(19) United States
(12) Patent Application Publication
(10) Pub. No.: US 2024/0244639 A1
(43) Pub. Date: Jul. 18, 2024

(54) INFORMATION TRANSMISSION METHOD AND APPARATUS

(71) Applicant: HUAWEI TECHNOLOGIES CO., LTD., Shenzhen (CN)

(72) Inventors: Wenwen HUANG, Shenzhen (CN); Xiaolei TIE, Shanghai (CN); Zhanzhan ZHANG, Shanghai (CN)

(21) Appl. No.: 18/621,980

(22) Filed: Mar. 29, 2024

Related U.S. Application Data
(63) Continuation of application No. PCT/CN2022/118774, filed on Sep. 14, 2022.

(30) Foreign Application Priority Data
Sep. 30, 2021 (CN) 202111159592.8

(51) Int. Cl. H04W 72/232; H04L 5/00; H04W 48/12

(52) U.S. Cl. CPC H04W 72/232; H04L 5/0094; H04W 48/12

(57) ABSTRACT

An information transmission method. A terminal device receives first indication information for monitoring combination from a network device. The first indication information for monitoring combination is usable to indicate at least two candidate monitoring behaviors. The terminal device receives downlink control information DCI from the network device. The DCI is usable to indicate a monitoring behavior of the terminal device. The monitoring behavior is one of the at least two candidate monitoring behaviors. The terminal device performs a downlink control channel PDCCH monitoring behavior based on the first indication information for monitoring combination and the DCI.

### CROSS-REFERENCE TO RELATED APPLICATIONS

This application is a continuation of International Application No. PCT/CN2022/118774, filed on Sep. 14, 2022, which claims priority to Chinese Patent Application No. 202111159592.8, filed on Sep. 30, 2021. The disclosures of the aforementioned applications are hereby incorporated by reference in their entireties.

### TECHNICAL FIELD

This disclosure relates to the communication field, and more specifically, to an information transmission method and an apparatus.

### BACKGROUND

In a wireless communication system, power consumption of a terminal device is an important aspect of user experience, and one factor that causes large power consumption of the terminal device is monitoring of a downlink control channel (e.g. Physical Downlink Control Channel, PDCCH) from a network device. Therefore, a solution to minimize unnecessary PDCCH monitoring is desired.

### SUMMARY

Embodiments described herein provide a monitoring indication solution, to reduce PDCCH monitoring by a terminal device, and further reduce power consumption.

According to a first aspect, an information transmission method is provided. The method includes: A terminal device receives first indication information for monitoring combination from a network device, where the first indication information for monitoring combination indicates at least two candidate monitoring behaviors. The terminal device receives downlink control information DCI from the network device, where the DCI indicates a monitoring behavior of the terminal device, and the monitoring behavior is one of the at least two candidate monitoring behaviors. The terminal device performs a downlink control channel (e.g. PDCCH) monitoring behavior based on the first indication information for monitoring combination and the DCI.

Therefore, in at least one embodiment, the terminal device determines the monitoring behavior based on the configured monitoring combination indication and the DCI, to effectively reduce power consumption of the terminal device and reduce implementation complexity of the terminal device.

In some embodiments of the first aspect, that a terminal device receives first indication information for monitoring combination from a network device includes: The terminal device receives the first indication information for monitoring combination from the network device. The first indication information for monitoring combination indicates one of the following: a first monitoring combination, including a first candidate monitoring behavior and a second candidate monitoring behavior; a second monitoring combination, including the second candidate monitoring behavior, a third candidate monitoring behavior, and a fourth candidate monitoring behavior; a third monitoring combination, including the second candidate monitoring behavior, the third candidate monitoring behavior, the fourth candidate monitoring behavior, and a fifth candidate monitoring behavior; a fourth monitoring combination, including the third candidate monitoring behavior and the fourth candidate monitoring behavior; or a fifth monitoring combination, including the third candidate monitoring behavior, the fourth candidate monitoring behavior, and the fifth candidate monitoring behavior. In addition, the first candidate monitoring behavior indicates to perform PDCCH monitoring based on a configured search space set, the second candidate monitoring behavior indicates to stop PDCCH monitoring within preset duration, the third candidate monitoring behavior indicates to perform PDCCH monitoring based on a search space set in a first search space set group, the fourth candidate monitoring behavior indicates to perform PDCCH monitoring based on a search space set in a second search space set group, and the fifth candidate monitoring behavior indicates to perform PDCCH monitoring based on a search space set in a third search space set group.

Therefore, each monitoring combination includes at least two candidate monitoring behaviors that are not mutually exclusive, to avoid unreasonable random indication.

In some embodiments of the first aspect, the first indication information for monitoring combination indicates the first monitoring combination, the second monitoring combination, or the third monitoring combination, and the method further includes: The terminal device receives indication information of the preset duration from the network device.

In some embodiments of the first aspect, the method further includes: The terminal device determines the monitoring behavior from the at least two candidate monitoring behaviors based on the DCI.

In some embodiments of the first aspect, the first indication information for monitoring combination indicates a monitoring combination of a first bandwidth part BWP, and the method further includes: The terminal device receives second indication information for monitoring combination from the network device, where the second indication information for monitoring combination indicates a monitoring combination of a second BWP.

Therefore, in response to a plurality of BWPs being configured for the terminal device, monitoring combinations is separately configured for different BWPs, to implement flexible configuration for the different BWPs.

In some embodiments of the first aspect, the monitoring combination of the first BWP is the same as the monitoring combination of the second BWP.

In particular, for a plurality of different BWPs belonging to a same cell, a same monitoring combination is configured for the plurality of different BWPs, to ensure consistency between different BWPs.

In some embodiments of the first aspect, the first indication information for monitoring combination indicates a monitoring combination of a first cell, and the method further includes: The terminal device receives third indication information for monitoring combination from the network device, where the third indication information for monitoring combination indicates a monitoring combination of a second cell.

Therefore, in response to a plurality of cells being configured for the terminal device, monitoring combinations is separately configured for different cells, to implement flexible configuration for the different cells.

In some embodiments of the first aspect, the monitoring combination of the first cell is the same as the monitoring combination of the second cell.

In particular, for a plurality of different cells belonging to a same cell group, a same monitoring combination is configured for the plurality of different cells, to ensure consistency between different cells.

In some embodiments of the first aspect, the method further includes: The terminal device sends supported monitoring combination information to the network device, where the supported monitoring combination information indicates a monitoring combination supported by the terminal device.

Therefore, the terminal device notifies the network device of the supported monitoring combination, to ensure that the monitoring combination indicated by the first indication information for monitoring combination sent by the network device is supported by the terminal device, and ensure information accuracy.

In some embodiments of the first aspect, the monitoring behavior is used for a type 3 common search space set and a terminal device-specific search space set.

According to a second aspect, an information transmission method is provided. The method includes: A network device sends first indication information for monitoring combination to a terminal device, where the first indication information for monitoring combination indicates at least two candidate monitoring behaviors. The network device sends downlink control information DCI to the terminal device, so that the terminal device performs a downlink control channel (e.g. PDCCH) monitoring behavior based on the first indication information for monitoring combination and the DCI. The monitoring behavior is one of the at least two candidate monitoring behaviors.

In some embodiments of the second aspect, that a network device sends first indication information for monitoring combination to a terminal device includes: The network device sends the first indication information for monitoring combination to the terminal device. The first indication information for monitoring combination indicates one of the following: a first monitoring combination, including a first candidate monitoring behavior and a second candidate monitoring behavior; a second monitoring combination, including the second candidate monitoring behavior, a third candidate monitoring behavior, and a fourth candidate monitoring behavior; a third monitoring combination, including the second candidate monitoring behavior, the third candidate monitoring behavior, the fourth candidate monitoring behavior, and a fifth candidate monitoring behavior; a fourth monitoring combination, including the third candidate monitoring behavior and the fourth candidate monitoring behavior; or a fifth monitoring combination, including the third candidate monitoring behavior, the fourth candidate monitoring behavior, and the fifth candidate monitoring behavior. In addition, the first candidate monitoring behavior indicates to perform PDCCH monitoring based on a configured search space set, the second candidate monitoring behavior indicates to stop PDCCH monitoring within preset duration, the third candidate monitoring behavior indicates to perform PDCCH monitoring based on a search space set in a first search space set group, the fourth candidate monitoring behavior indicates to perform PDCCH monitoring based on a search space set in a second search space set group, and the fifth candidate monitoring behavior indicates to perform PDCCH monitoring based on a search space set in a third search space set group.

In some embodiments of the second aspect, the first indication information for monitoring combination indicates the first monitoring combination, the second monitoring combination, or the third monitoring combination, and the method further includes: The network device sends indication information of the preset duration to the terminal device.

In some embodiments of the second aspect, the first indication information for monitoring combination indicates a monitoring combination of a first bandwidth part BWP, and the method further includes: The network device sends second indication information for monitoring combination to the terminal device, where the second indication information for monitoring combination indicates a monitoring combination of a second BWP.

In some embodiments of the second aspect, the monitoring combination of the first BWP is the same as the monitoring combination of the second BWP.

In some embodiments of the second aspect, the first indication information for monitoring combination indicates a monitoring combination of a first cell, and the method further includes: The network device sends third indication information for monitoring combination to the terminal device, where the third indication information for monitoring combination indicates a monitoring combination of a second cell.

In some embodiments of the second aspect, the monitoring combination of the first cell is the same as the monitoring combination of the second cell.

In some embodiments of the second aspect, the method further includes: The network device receives supported monitoring combination information from the terminal device, where the supported monitoring combination information indicates a monitoring combination supported by the terminal device, and a monitoring combination indicated by the first indication information for monitoring combination belongs to the monitoring combination supported by the terminal device.

In some embodiments of the second aspect, the monitoring behavior is used for a type 3 common search space set and a terminal device-specific search space set.

According to a third aspect, a communication apparatus is provided. The apparatus includes: a first receiving module, configured to receive first indication information for monitoring combination from a network device, where the first indication information for monitoring combination indicates at least two candidate monitoring behaviors; a second receiving module, configured to receive downlink control information DCI from the network device, where the DCI indicates a monitoring behavior of the communication apparatus, and the monitoring behavior is one of the at least two candidate monitoring behaviors; and an execution module, configured to perform a downlink control channel (e.g. PDCCH) monitoring behavior based on the first indication information for monitoring combination and the DCI.

In some embodiments of the third aspect, the first receiving module is configured to receive the first indication information for monitoring combination from the network device. The first indication information for monitoring combination indicates one of the following: a first monitoring combination, including a first candidate monitoring behavior and a second candidate monitoring behavior; a second monitoring combination, including the second candidate monitoring behavior, a third candidate monitoring behavior, and a fourth candidate monitoring behavior; a third monitoring combination, including the second candidate monitoring behavior, the third candidate monitoring behavior, the fourth candidate monitoring behavior, and a fifth candidate monitoring behavior; a fourth monitoring combination, including the third candidate monitoring behavior and the fourth candidate monitoring behavior; or a fifth monitoring combination, including the third candidate monitoring behavior, the fourth candidate monitoring behavior, and the fifth candidate monitoring behavior. In addition, the first candidate monitoring behavior indicates to perform PDCCH monitoring based on a configured search space set, the second candidate monitoring behavior indicates to stop PDCCH monitoring within preset duration, the third candidate monitoring behavior indicates to perform PDCCH monitoring based on a search space set in a first search space set group, the fourth candidate monitoring behavior indicates to perform PDCCH monitoring based on a search space set in a second search space set group, and the fifth candidate monitoring behavior indicates to perform PDCCH monitoring based on a search space set in a third search space set group.

In some embodiments of the third aspect, the first indication information for monitoring combination indicates the first monitoring combination, the second monitoring combination, or the third monitoring combination, and the communication apparatus further includes a third receiving module, configured to receive indication information of the preset duration from the network device.

In some embodiments of the third aspect, the apparatus further includes a determining module, configured to determine the monitoring behavior from the at least two candidate monitoring behaviors based on the DCI.

In some embodiments of the third aspect, the first indication information for monitoring combination indicates a monitoring combination of a first bandwidth part BWP, and the first receiving module is further configured to receive second indication information for monitoring combination from the network device, where the second indication information for monitoring combination indicates a monitoring combination of a second BWP.

In some embodiments of the third aspect, the monitoring combination of the first BWP is the same as the monitoring combination of the second BWP.

In some embodiments of the third aspect, the first indication information for monitoring combination indicates a monitoring combination of a first cell, and the first receiving module is further configured to receive third indication information for monitoring combination from the network device, where the third indication information for monitoring combination indicates a monitoring combination of a second cell.

In some embodiments of the third aspect, the monitoring combination of the first cell is the same as the monitoring combination of the second cell.

In some embodiments of the third aspect, the apparatus further includes a sending module, configured to send supported monitoring combination information to the network device, where the supported monitoring combination information indicates a monitoring combination supported by the communication apparatus.

In some embodiments of the third aspect, the monitoring behavior is used for a type 3 common search space set and a terminal device-specific search space set.

According to a fourth aspect, a communication apparatus is provided. The apparatus includes: a first sending module, configured to send first indication information for monitoring combination to a terminal device, where the first indication information for monitoring combination indicates at least two candidate monitoring behaviors; and a second sending module, configured to send downlink control information DCI to the terminal device, so that the terminal device performs a downlink control channel (e.g. PDCCH) monitoring behavior based on the first indication information for monitoring combination and the DCI. The monitoring behavior is one of the at least two candidate monitoring behaviors.

In some embodiments of the fourth aspect, the first sending module is configured to send the first indication information for monitoring combination to the terminal device. The first indication information for monitoring combination indicates one of the following: a first monitoring combination, including a first candidate monitoring behavior and a second candidate monitoring behavior; a second monitoring combination, including the second candidate monitoring behavior, a third candidate monitoring behavior, and a fourth candidate monitoring behavior; a third monitoring combination, including the second candidate monitoring behavior, the third candidate monitoring behavior, the fourth candidate monitoring behavior, and a fifth candidate monitoring behavior; a fourth monitoring combination, including the third candidate monitoring behavior and the fourth candidate monitoring behavior; or a fifth monitoring combination, including the third candidate monitoring behavior, the fourth candidate monitoring behavior, and the fifth candidate monitoring behavior. In addition, the first candidate monitoring behavior indicates to perform PDCCH monitoring based on a configured search space set, the second candidate monitoring behavior indicates to stop PDCCH monitoring within preset duration, the third candidate monitoring behavior indicates to PDCCH monitoring based on a search space set in a first search space set group, the fourth candidate monitoring behavior indicates to perform PDCCH monitoring based on a search space set in a second search space set group, and the fifth candidate monitoring behavior indicates to perform PDCCH monitoring based on a search space set in a third search space set group.

In some embodiments of the fourth aspect, the first indication information for monitoring combination indicates the first monitoring combination, the second monitoring combination, or the third monitoring combination, and the communication apparatus further includes a third sending module, configured to send indication information of the preset duration to the terminal device.

In some embodiments of the fourth aspect, the first indication information for monitoring combination indicates a monitoring combination of a first bandwidth part BWP, and the first sending module is further configured to send a second indication information for monitoring combination to the terminal device, where the second indication information for monitoring combination indicates a monitoring combination of a second BWP.

In some embodiments of the fourth aspect, the monitoring combination of the first BWP is the same as the monitoring combination of the second BWP.

In some embodiments of the fourth aspect, the first indication information for monitoring combination indicates a monitoring combination of a first cell, and the first sending module is further configured to send a third indication information for monitoring combination to the terminal device, where the third indication information for monitoring combination indicates a monitoring combination of a second cell.

In some embodiments of the fourth aspect, the monitoring combination of the first cell is the same as the monitoring combination of the second cell.

In some embodiments of the fourth aspect, the apparatus further includes a receiving module, configured to receive supported monitoring combination information from the terminal device, where the supported monitoring combination information indicates a monitoring combination supported by the terminal device, and a monitoring combination indicated by the first indication information for monitoring combination belongs to the monitoring combination supported by the terminal device.

In some embodiments of the fourth aspect, the monitoring behavior is used for a type 3 common search space set and a terminal device-specific search space set.

According to a fifth aspect, a terminal device is provided. The terminal device includes a transceiver, a processor, and a memory. The memory stores instructions executed by the processor. In response to the instructions being executed by the processor, the terminal device is enabled to: receive, by using the transceiver, first indication information for monitoring combination from a network device, where the first indication information for monitoring combination indicates at least two candidate monitoring behaviors; receive, by using the transceiver, downlink control information DCI from the network device, where the DCI indicates a monitoring behavior of the terminal device, and the monitoring behavior is one of the at least two candidate monitoring behaviors; and perform a downlink control channel (e.g. PDCCH) monitoring behavior based on the first indication information for monitoring combination and the DCI.

In some embodiments of the fifth aspect, the processor executes the instructions to enable the terminal device to receive, by using the transceiver, the first indication information for monitoring combination from the network device. The first indication information for monitoring combination indicates one of the following: a first monitoring combination, including a first candidate monitoring behavior and a second candidate monitoring behavior; a second monitoring combination, including the second candidate monitoring behavior, a third candidate monitoring behavior, and a fourth candidate monitoring behavior; a third monitoring combination, including the second candidate monitoring behavior, the third candidate monitoring behavior, the fourth candidate monitoring behavior, and a fifth candidate monitoring behavior; a fourth monitoring combination, including the third candidate monitoring behavior and the fourth candidate monitoring behavior; or a fifth monitoring combination, including the third candidate monitoring behavior, the fourth candidate monitoring behavior, and the fifth candidate monitoring behavior. In addition, the first candidate monitoring behavior indicates to perform PDCCH monitoring based on a configured search space set, the second candidate monitoring behavior indicates to stop PDCCH monitoring within preset duration, the third candidate monitoring behavior indicates to perform PDCCH monitoring based on a search space set in a first search space set group, the fourth candidate monitoring behavior indicates to perform PDCCH monitoring based on a search space set in a second search space set group, and the fifth candidate monitoring behavior indicates to perform PDCCH monitoring based on a search space set in a third search space set group.

In some embodiments of the fifth aspect, the first indication information for monitoring combination indicates the first monitoring combination, the second monitoring combination, or the third monitoring combination, and the processor executes the instructions to enable the terminal device to receive, by using the transceiver, indication information of the preset duration from the network device.

In some embodiments of the fifth aspect, the processor executes the instructions to enable the terminal device to determine the monitoring behavior from the at least two candidate monitoring behaviors based on the DCI.

In some embodiments of the fifth aspect, the first indication information for monitoring combination indicates a monitoring combination of a first bandwidth part BWP, and the processor executes the instructions to enable the terminal device to receive, by using the transceiver, second indication information for monitoring combination from the network device, where the second indication information for monitoring combination indicates a monitoring combination of a second BWP.

In some embodiments of the fifth aspect, the monitoring combination of the first BWP is the same as the monitoring combination of the second BWP.

In some embodiments of the fifth aspect, the first indication information for monitoring combination indicates a monitoring combination of a first cell, and the processor executes the instructions to enable the terminal device to receive, by using the transceiver, third indication information for monitoring combination from the network device, where the third indication information for monitoring combination indicates a monitoring combination of a second cell.

In some embodiments of the fifth aspect, the monitoring combination of the first cell is the same as the monitoring combination of the second cell.

In some embodiments of the fifth aspect, the processor executes the instructions to enable the terminal device to send supported monitoring combination information to the network device, where the supported monitoring combination information indicates a monitoring combination supported by the terminal device.

In some embodiments of the fifth aspect, the monitoring behavior is used for a type 3 common search space set and a terminal device-specific search space set.

According to a sixth aspect, a network device is provided. The network device includes a transceiver, a processor, and a memory. The memory stores instructions executed by the processor. In response to the instructions being executed by the processor, the network device is enabled to: send, by using the transceiver, first indication information for monitoring combination to a terminal device, where the first indication information for monitoring combination indicates at least two candidate monitoring behaviors; send, by using the transceiver, downlink control information DCI to the terminal device, so that the terminal device performs a downlink control channel (e.g.PDCCH) monitoring behavior based on the first indication information for monitoring combination and the DCI. The monitoring behavior is one of the at least two candidate monitoring behaviors.

In some embodiments of the sixth aspect, the processor executes the instructions to enable the network device to send, by using the transceiver, the first indication information for monitoring combination to the terminal device. The first indication information for monitoring combination indicates one of the following: a first monitoring combination, including a first candidate monitoring behavior and a second candidate monitoring behavior; a second monitoring combination, including the second candidate monitoring behavior, a third candidate monitoring behavior, and a fourth candidate monitoring behavior; a third monitoring combination, including the second candidate monitoring behavior, the third candidate monitoring behavior, the fourth candidate monitoring behavior, and a fifth candidate monitoring behavior; a fourth monitoring combination, including the third candidate monitoring behavior and the fourth candidate monitoring behavior; or a fifth monitoring combination, including the third candidate monitoring behavior, the fourth candidate monitoring behavior, and the fifth candidate monitoring behavior. In addition, the first candidate monitoring behavior indicates to perform PDCCH monitoring based on a configured search space set, the second candidate monitoring behavior indicates to stop PDCCH monitoring within preset duration, the third candidate monitoring behavior indicates to perform PDCCH monitoring based on a search space set in a first search space set group, the fourth candidate monitoring behavior indicates to perform PDCCH monitoring based on a search space set in a second search space set group, and the fifth candidate monitoring behavior indicates to perform PDCCH monitoring based on a search space set in a third search space set group.

In some embodiments of the sixth aspect, the first indication information for monitoring combination indicates the first monitoring combination, the second monitoring combination, or the third monitoring combination, and the processor executes the instructions to enable the network device to send, by using the transceiver, indication information of the preset duration to the terminal device.

In some embodiments of the sixth aspect, the first indication information for monitoring combination indicates a monitoring combination of a first bandwidth part BWP, and the processor executes the instructions to enable the network device to send, by using the transceiver, second indication information for monitoring combination to the terminal device, where the second indication information for monitoring combination indicates a monitoring combination of a second BWP.

In some embodiments of the sixth aspect, the monitoring combination of the first BWP is the same as the monitoring combination of the second BWP.

In some embodiments of the sixth aspect, the first indication information for monitoring combination indicates a monitoring combination of a first cell, and the processor executes the instructions to enable the network device to send, by using the transceiver, third indication information for monitoring combination to the terminal device, where the third indication information for monitoring combination indicates a monitoring combination of a second cell.

In some embodiments of the sixth aspect, the monitoring combination of the first cell is the same as the monitoring combination of the second cell.

In some embodiments of the sixth aspect, the processor executes the instructions to enable the network device to receive, by using the transceiver, supported monitoring combination information from the terminal device, where the supported monitoring combination information indicates a monitoring combination supported by the terminal device, and a monitoring combination indicated by the first indication information for monitoring combination belongs to the monitoring combination supported by the terminal device.

In some embodiments of the sixth aspect, the monitoring behavior is used for a type 3 common search space set and a terminal device-specific search space set.

According to a seventh aspect, a computer-readable storage medium is provided. The computer-readable storage medium stores computer-executable instructions, and in response to the computer-executable instructions being executed by a processor, an operation based on the method in any one of the first aspect or the embodiments of the first aspect is implemented, or an operation based on the method in any one of the second aspect or the embodiments of the second aspect is implemented.

According to an eighth aspect, a chip or a chip system is provided. The chip or the chip system includes a processing circuit configured to perform an operation based on the method in any one of the first aspect or the embodiments of the first aspect or an operation based on the method in any one of the second aspect or the embodiments of the second aspect.

According to a ninth aspect, a computer program or a computer program product is provided. The computer program or the computer program product is tangibly stored in a computer-readable medium, and includes computer-executable instructions. In response to the computer-executable instructions being executed, an operation based on the method in any one of the first aspect or the embodiments of the first aspect is implemented, or an operation based on the method in any one of the second aspect or the embodiments of the second aspect is implemented.

### BRIEF DESCRIPTION OF DRAWINGS

The foregoing and other features, advantages, and aspects of embodiments described herein become more apparent in conjunction with the accompanying drawings and with reference to the following detailed descriptions. In the accompanying drawings, same or similar reference numerals represent same or similar elements.

FIG. 1 is a schematic diagram of PDCCH monitoring;

FIG. 2 is a schematic diagram of skipping PDCCH monitoring;

FIG. 3 is a schematic diagram of grouping four search space sets;

FIG. 4 is a schematic diagram of a communication system in which at least one embodiment is implemented;

FIG. 5 is a diagram of signaling interaction of a process between a terminal device and a network device according to at least one embodiment;

FIG. 6 is a schematic block diagram of a communication apparatus for information transmission according to at least one embodiment;

FIG. 7 is another schematic block diagram of a communication apparatus for information transmission according to at least one embodiment; and

FIG. 8 is a schematic block diagram of an example device that is used to implement at least one embodiment.

### DESCRIPTION OF EMBODIMENTS

Embodiments described herein are described in more detail in the following with reference to the accompanying drawings. Although at least one embodiment is shown in the accompanying drawings, at least one embodiment is implemented in various forms, and should not be construed as being limited to the embodiments described herein. On the contrary, these embodiments are provided to provide a through and complete understanding. The accompanying drawings and embodiments described herein are merely used as examples, but are not intended to limit the protection scope of embodiments described herein.

In at least one embodiment, the term “include” and similar terms thereof should be understood as open inclusion, that is, “include but are not limited to”. The term “based” should be understood as “at least partially based”. The terms “one embodiment” or “this embodiment” should be understood as “at least one embodiment”. The terms “first”, “second”, and the like indicate different or same objects. Other explicit and implicit definitions are also included below.

Embodiments described herein are implemented according to any appropriate communication protocol that includes but is not limited to: 3rd generation, (3G), 4th generation (4G), 5th generation (5G), 6th generation (6G), and another cellular communication protocols, a wireless local area network communication protocol, for example, the Institute of Electrical and Electronics Engineers (IEEE) 802.11, and/or any other protocol currently known or developed in the future.

Technical solutions of at least one embodiment are applied to a communication system that complies with any appropriate communication protocol, for example, a long term evolution (LTE) system, a frequency division duplex (FDD) system, a time division duplex (TDD) system, a 5th generation (5G) system, or a new radio (NR) system, a 6th generation (6G) system, and the like.

For purposes of illustration, embodiments are described below in context of an NR communication system in the 3GPP. However, embodiments described herein are understood to not be limited to the communication system, but are applied to any communication system that has a similar problem, for example, a wireless local area network (WLAN), a wired communication system, or another communication system developed in the future.

The term “terminal device” used in at least one embodiment means any terminal device that performs wired or wireless communication with a network device or with another terminal device. The terminal device is sometimes referred to as user equipment (UE). The terminal device is any type of mobile terminal, fixed terminal, or portable terminal. For example, the terminal device includes a mobile phone, a station, a unit, a device, a mobile terminal (MT), a subscription platform, a portable subscription platform, an Internet node, a communicator, a desktop computer, a laptop computer, a notebook computer, a tablet computer, a personal communication system device, a personal navigation device, a personal digital assistant (PDA), a positioning device, a radio broadcast receiver, an e-book device, a game device, an Internet of things (IoT) device, a vehicle-mounted device, an aircraft, a virtual reality (VR) device, an augmented reality (AR) device, a wearable device, a terminal device in a 5G network, any terminal device in an evolved public land mobile network (PLMN), another device that is used for communication, or any combination thereof. This is not limited in at least one embodiment.

The term “network device” used in at least one embodiment is an entity or a node, for example, an access network device, that is configured to communicate with the terminal device. The access network device is an apparatus, for example, a radio access network (RAN) device deployed in a radio access network to provide a wireless communication function for the mobile terminal. The access network device includes various types of base stations. For example, the access network device includes a macro base station, a micro base station, a pico base station, a femto base station, a relay station, an access point, a remote radio unit (RRU), a radio head (RH), a remote radio head (RRH), and the like in various forms. In systems that use different radio access technologies, names of access network devices are different. For example, the access network device is referred to as an evolved NodeB eNB or eNodeB) in a long term evolution (LTE) network, referred to as a NodeB (NB) in a 3G network, referred to as a gNodeB (gNB) or an NR NodeB (NR NB) in a 5G network, and the like. In some scenarios, the access network device includes a central unit (CU) and/or a distributed unit (DU). The CU and DU are placed in different places. For example, the DU is remotely placed in a high-traffic area, and the CU is placed in a central equipment room. Alternatively, the CU and the DU are placed in a same equipment room. Alternatively, the CU and the DU are different components in a same rack. For ease of description, in subsequent embodiments described herein, the foregoing apparatuses that provide a wireless communication function for the terminal device are collectively referred to as network devices. This is not specifically limited in at least one embodiment.

A physical downlink channel corresponds to a set of resource elements (RE) that carry information from a higher layer. A PDCCH is a physical downlink channel that carries scheduling information and other control information. The PDCCH carries scheduling information of uplink data and/or downlink data, and the terminal device periodically performs PDCCH monitoring, to obtain the scheduling information. In response to the terminal device obtaining the scheduling information through monitoring, the terminal device further receives the downlink data through a physical downlink shared channel (PDSCH), or send the uplink data through a physical uplink shared channel (PUSCH) based on the scheduling information. The PDCCH further carries information such as an uplink power control command word and a slot format. PDCCHs that carry different control information are scrambled by using different radio network temporary identifiers (RNTI).

Monitoring performed by the terminal device on the PDCCH is also referred to as listening, detecting or the like. This term is not limited in at least one embodiment.

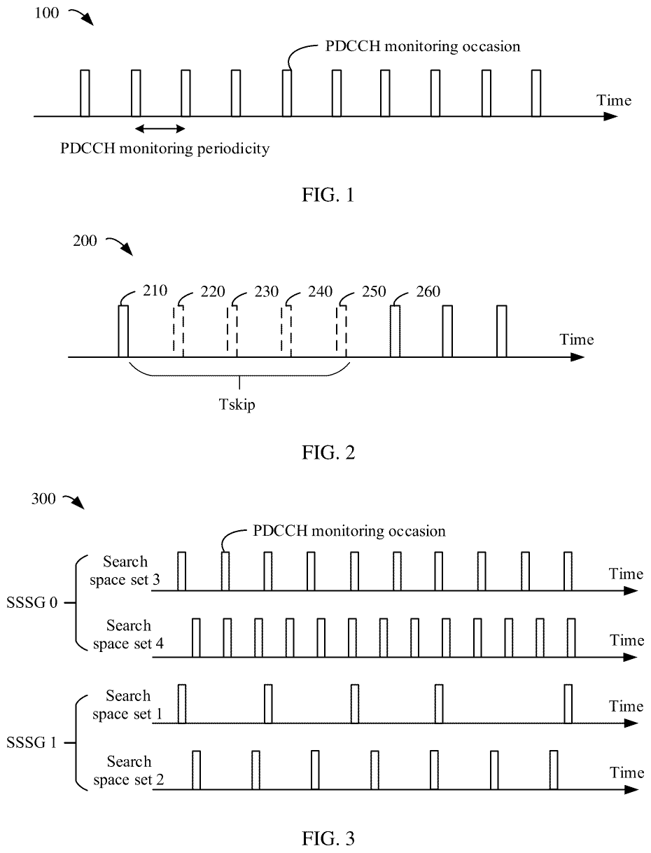

The PDCCH is transmitted on an aggregation of one or more consecutive control channel elements (CCE), and one CCE corresponds to six resource element groups (REG). The network device configures at least one search space set (SSS) for the terminal device, and one search space set is used to define a group of candidate PDCCHs. The terminal device determines a PDCCH monitoring occasion (MO) based on configuration information of the search space set, and further performs PDCCH monitoring on the determined PDCCH monitoring occasion, as shown in FIG. 1. The PDCCH monitoring occasion is also referred to as a PDCCH candidate location.

The configuration information of the search space set includes at least one of the following:
(1) identification information, of a search space set, used to identify the search space set;
(2) identification information of a control resource set (CORESET) associated with the search space set, where the CORESET indicates a time-frequency resource set used to carry the PDCCH; and one CORESET includes several consecutive or non-consecutive resource blocks (RB) in frequency domain, and includes one or more consecutive symbols in time domain;
(3) a PDCCH monitoring periodicity (for example, represented by Ks) and offset (for example, represented by Os), where dimensions of Ks and Os is a slot, or optionally, the dimension of Os is a symbol;
(4) a PDCCH monitoring pattern within a slot, where the PDCCH monitoring pattern within a slot is also referred to as a PDCCH monitoring symbol within a slot, and indicates a start symbol of the CORESET, associated with the search space set, within a slot for PDCCH monitoring;
(5) duration (for example, represented by Ts), where the duration indicates a quantity of consecutive slots that the search space set exists, Ts is less than Ks, and a value of Ts is one slot;
(6) an aggregation level and a quantity of PDCCH candidates corresponding to each aggregation level; and
(7) search space set type indication information, where the search space set type indication information indicates whether the search space set is a common search space set (CSS set) or a user equipment-specific search space set (USS set). For example, the common search space set is referred to as a CSS, and the user equipment-specific search space set is referred to as a USS.

For example, the common search space set includes a type-3 common search space (type-3 CSS) set that is mainly used to monitor a PDCCH that carries DCI scrambled by any one of the following radio network temporary identifiers (RNTI): an interruption-RNTI (INT-RNTI), a slot format indication-RNTI (SFI-RNTI), a transmit power control-physical uplink shared channel-RNTI (TPC-PUSCH-RNTI), a transmit power control-physical uplink control channel-RNTI (TPC-PUCCH-RNTI), a transmit power control-sounding reference signal-RNTI (TPC-SRS-RNTI), a cancellation indication-RNTI (CI-RNTI), a cell-RNTI (C-RNTI) on a primary cell, a modulation and coding scheme-C-RNTI (MCS-C-RNTI), a configured scheduling-RNTI (CS-RNTI), a power saving-RNTI (PS-RNTI), or the like.

For example, the user equipment-specific search space set is used to monitor a PDCCH that carries DCI scrambled by any one of the following RNTIs: a C-RNTI, an MCS-C-RNTI, a semi-persistent-channel state indication-RNTI (SP-CSI-RNTI), a CS-RNTI, a side link-RNTI (SL-RNTI), an SL-CS-RNTI, a side link semi-persistent scheduling vehicle-RNTI (SL Semi-Persistent Scheduling V-RNTI), and the like.

In addition, in response to a type of the search space set being the CSS, the network device further configures a downlink control information (DCI) format, for example, DCI format 0_0, DCI format 1_0, DCI format 2_0, DCI format 2_1, DCI format 2_2, DCI format 2_3, DCI format 2_4, DCI format 2_5, or DCI format 2_6, monitored at the PDCCH candidate location. In response to the type of the search space set being the USS, the network device further configures the DCI format, for example, DCI format 00, DCI format 10, DCI format 0_1, DCI format 1_1, DCI format 02, DCI format 1_2, DCI format 3_0, or DCI format 3_1, monitored at the PDCCH candidate location. For example, different usage corresponding to different DCI formats is shown in Table 1. However, Table 1 is merely an example, and there are more or fewer types of DCI formats in an actual scenario. In some scenarios, a DCI format has different usage from that in Table 1.

Therefore, the terminal device performs PDCCH monitoring based on the configuration information of the search space set. Specifically, the terminal device monitors, based on the PDCCH monitoring periodicity and offset, the PDCCH monitoring pattern within a slot, and the like included in the configuration information of the search space set, the PDCCH on the CORESET associated with the search space set.

TABLE 1

| DCI format | Usage |
|---|---|
| 0_0 | Schedule a PUSCH in one cell |
| 0_1 | Schedule one or more PUSCHs in one cell, |
| | or indicate configured grant PUSCH |
| | downlink feedback information (CG-DFI) |
| 0_2 | Schedule a PUSCH in one cell |
| 1_0 | Schedule a PDSCH in one cell |
| 1_1 | Schedule a PDSCH in one cell, and/or |
| | trigger a HARQ-ACK codebook feedback |
| 1_2 | Schedule a PDSCH in one cell |
| 2_0 | Notify a group of UEs of a slot format, |
| | an available RB set, COT duration, and |
| | search space set group switching |
| 2_1 | Notify a group of UEs of a PRB and an |
| | OFDM symbol where the UE assumes no |
| | transmission is intended for the UE |
| 2_2 | Transmit TPC commands for a PUCCH |
| | and the PUSCH |
| 2_3 | Transmit a group of TPC commands for |
| | SRS transmissions by one or more UEs |
| 2_4 | Notify a group of UEs of a PRB and |
| | an OFDM symbol where UE cancels a |
| | corresponding UL transmission from the UE |
| 2_5 | Notify availability of a soft resource, |
| | as defined in Section 9.3.1 in TS 38.473 |
| 2_6 | Notify power saving information outside |
| | DRX active time for one or more UEs |
| 3_0 | Schedule an NR sidelink in one cell |
| 3_1 | Schedule an LTE sidelink in one cell |

The terminal device periodically performs PDCCH monitoring based on the PDCCH monitoring periodicity. However, in response to there being no to-be-transmitted service between the network device and the terminal device, periodic monitoring of the terminal device causes a waste of power consumption. To reduce power consumption of the terminal device, unnecessary PDCCH monitoring is reduced by using a mechanism of skipping PDCCH monitoring or a search space set group switching mechanism.

### Mechanism of Skipping PDCCH Monitoring

Specifically, the network device indicates, by using DCI, the terminal device to skip PDCCH monitoring in subsequent duration (or to stop PDCCH monitoring in duration, or not to perform PDCCH monitoring in duration).

FIG. 2 is a schematic diagram of skipping PDCCH monitoring 200. Refer to FIG. 2. On a PDCCH monitoring occasion 210, the terminal device obtains the DCI from the network device by PDCCH monitoring, and the DCI indicates the terminal device to skip PDCCH monitoring in subsequent duration (represented by Tskip). In this case, the terminal device does not perform PDCCH monitoring on 220 to 250 in Tskip, but continues to perform PDCCH monitoring on a PDCCH monitoring occasion 260 after Tskip. An understanding is that 220 to 250 in FIG. 2 are PDCCH monitoring occasions on which monitoring is skipped and determined based on the configuration information of the search space set.

In addition, for example, the skipped duration Tskip is indicated by using the DCI, and/or configured by using radio resource control (RRC) signaling, or predefined by using a protocol. For example, the RRC signaling is used to configure values of a plurality of pieces of skipped duration, and indicate, by using the DCI, one of the plurality of values as current skipped duration.

Skipping PDCCH monitoring includes skipping PDCCH monitoring on a type 3 common search space set and skipping PDCCH monitoring on the user equipment-specific search space set. For another type of common search space set, for example, type 0, type 0A, type 1, and type 2 common search space sets, the terminal device skips or does not skip PDCCH monitoring with DCI scrambled by a C-RNTI, an MCS-C-RNTI, or a CS-RNTI. This is not limited in at least one embodiment. For the type 0, type 0A, type 1, and type 2 common search space sets, whether the terminal device performs PDCCH monitoring with DCI scrambled by an SI-RNTI, an RA-RNTI, a TC-RNTI, or a P-RNTI is not limited in at least one embodiment.

The type 0 and type 0A common search space sets are used to perform PDCCH monitoring with DCI scrambled by a system information-RNTI (SI-RNTI). The type-1 common search space set is used to perform PDCCH monitoring with DCI scrambled by a random access-RNTI (RA-RNTI), a message B-RNTI (MsgB-RNTI), or a temporary cell-RNTI (TC-RNTI). The type 2 common search space set is used to perform PDCCH monitoring with DCI scrambled by a paging-RNTI (P-RNTI). For the type 0, type 0A, type 1, and type 2 common search space sets, in a slot in which the terminal device performs PDCCH monitoring with the DCI scrambled by the SI-RNTI, the RA-RNTI, the MsgB-RNTI, or the P-RNTI, the terminal device performs PDCCH monitoring with the DCI (DCI format 0_0 and DCI format 1_0) scrambled by the C-RNTI, the MCS-C-RNTI, or the CS-RNTI.

In this way, the terminal device enters a sleep state by skipping PDCCH monitoring in the duration Tskip, to reduce power consumption.

Skipping, by the terminal device, PDCCH monitoring is also referred to as stopping PDCCH monitoring, not performing PDCCH monitoring, or the like. This term is not limited in at least one embodiment.

### Search Space Set Group (SSSG) Switching Mechanism

Refer to the part with reference to FIG. 1. For one downlink bandwidth part (BWP), the network device configures a plurality of search space sets (SS set) for the terminal device. Further, the plurality of search space sets is grouped, for example, grouped into two groups, three groups, or more groups.

In response to the search space sets being grouped, the configuration information of the search space set further includes indication information indicating an SSSG to which the search space set belongs. For example, search space sets in one downlink BWP are grouped into two groups: an SSSG 0 and an SSSG 1. The indication information indicates whether the search space set belongs to the first group (SSSG 0) or the second group (SSSG 1). For example, the search space sets are grouped into three groups: an SSSG 0, an SSSG 1, and an SSSG 2. The indication information indicates whether the search space set belongs to the first group (SSSG 0), the second group (SSSG 1), or the third group (SSSG 2). In this way, the terminal device only performs PDCCH monitoring based on the search space set in the indicated SSSG. This reduces a quantity of times of performing PDCCH monitoring, and reduces power consumption. A specific search space set is long to two or three different SSSGs at the same time.

For an SS set that is not grouped, the terminal device still performs PDCCH monitoring based on the configuration information of the SS set. This is not limited in at least one embodiment.

FIG. 3 is a schematic diagram of grouping 300 of four search space sets in one downlink BWP. Refer to FIG. 3. The four search space sets are grouped, based on a sparsity degree of a PDCCH monitoring periodicity, into two groups: an SSSG 0 and an SSSG 1. The SSSG 0 includes a search space set 3 and a search space set 4, and the SSSG 1 includes a search space set 1 and a search space set 2.

For example, the search space set group indicated to the terminal device is the SSSG 1, the terminal device performs PDCCH monitoring based on the search space set 1 and the search space set 2 that belong to the SSSG 1, and does not perform PDCCH monitoring based on the search space set 3 and the search space set 4. Because a PDCCH monitoring periodicity of the search space set belonging to the SSSG 1 is sparser, a quantity of times of monitoring is reduced, and power consumption is reduced.

Optionally, the network device further indicates the terminal device to switch the search space set group. For example, the network device explicitly indicates SSSG switching by using a bit field in the DCI or implicitly indicates SSSG switching by using the DCI.

For example, search space sets are grouped into two groups: an SSSG 0 and an SSSG 1. An explicit indication manner is as follows: A specific bit field in the DCI is “0”, to indicate the terminal device to perform PDCCH monitoring based on the search space set belonging to the SSSG 0. A specific bit field in the DCI is “1”, to indicate the terminal device to perform PDCCH monitoring based on the search space set belonging to the SSSG 1. Alternatively, the explicit indication manner is as follows: A specific bit field in the DCI is “0”, to indicate the terminal device to perform PDCCH monitoring based on a search space set belonging to a current SSSG, that is, SSSG switching is not performed. A specific bit field in the DCI is “1”, to indicate the terminal device to perform SSSG switching (if a current SSSG is the SSSG 0, the terminal device switches to the SSSG 1; or in response to a current SSSG being the SSSG 1, the terminal device switches to the SSSG 0), and perform PDCCH monitoring based on a search space set belonging to an SSSG obtained through switching. An implicit indication manner is as follows: An SSSG of current PDCCH monitoring is the SSSG 0, and in response to the terminal device monitoring specific DCI or any DCI, the terminal device switches to the SSSG 1; or an SSSG of current PDCCH monitoring is the SSSG 1, and in response to the terminal device monitoring specific DCI or any DCI, the terminal device switches to the SSSG 0.

For another example, search space sets are grouped into three groups: an SSSG 0, an SSSG 1, and an SSSG 2. An explicit indication manner is as follows: A specific bit field in the DCI is “00”, to indicate the terminal device to perform PDCCH monitoring based on the search space set belonging to the SSSG 0. A specific bit field in the DCI is “01”, to indicate the terminal device to perform PDCCH monitoring based on the search space set belonging to the SSSG 1. A specific bit field in the DCI is “10”, to indicate the terminal device to perform PDCCH monitoring based on the search space set belonging to the SSSG 2. A specific bit field “11” in the DCI is reserved. Alternatively, the explicit indication manner is as follows: A specific bit field in the DCI is “0”, to indicate the terminal device to perform PDCCH monitoring based on a search space set belonging to a current SSSG, that is, SSSG switching is not performed. A specific bit field in the DCI is “1”, to indicate the terminal device to perform SSSG switching, and perform PDCCH monitoring based on a search space set belonging to an SSSG obtained through switching. SSSG switching is as follows: in response to a current SSSG being the SSSG 0, the terminal device switches to the SSSG 1; in response to a current SSSG being the SSSG 1, the terminal device switches to the SSSG 2; or in response to a current SSSG being the SSSG 2, the terminal device switches to the SSSG 0. An implicit indication manner is as follows: An SSSG of current PDCCH monitoring is an SSSG x, and in response to the terminal device monitoring specific DCI or any DCI, the terminal device switches to an SSSG y. The SSSG x and the SSSG y are predefined in a protocol, for example, the SSSG x is the SSSG 0, and the SSSG y is the SSSG 1.

Optionally, the terminal device alternatively switches the SSSG based on a timer.

For example, search space sets are grouped into two groups: an SSSG 0 and an SSSG 1. The terminal device performs PDCCH monitoring based on a search space set belonging to a current SSSG (for example, the SSSG 1), and starts the timer. After the timer expires, the terminal device switches to the SSSG 0, and performs PDCCH monitoring based on the search space set belonging to the SSSG 0.

For another example, search space sets are grouped into three groups: an SSSG 0, an SSSG 1, and an SSSG 2. The terminal device performs PDCCH monitoring based on a search space set belonging to a current SSSG (for example, the SSSG 1), and starts the timer. After the timer expires, the terminal device switches to the SSSG 2, performs PDCCH monitoring based on the search space set belonging to the SSSG 2, and resets the timer. After the timer expires, the terminal device switches to the SSSG 0, and performs PDCCH monitoring based on the search space set belonging to the SSSG 0. For another example, the terminal device performs PDCCH monitoring based on the search space set belonging to the SSSG 1, and starts the timer. After the timer expires, the terminal device switches to the SSSG 0, and performs PDCCH monitoring based on the search space set belonging to the SSSG 0. The terminal device performs PDCCH monitoring based on the search space set belonging to the SSSG 2, and starts the timer. After the timer expires, the terminal device switches to the SSSG 0, and performs PDCCH monitoring based on the search space set belonging to the SSSG 0. In other words, regardless of whether the terminal device currently performs PDCCH monitoring based on the search space set of the SSSG 1 or the search space set of the SSSG 2, after the timer expires, the terminal device switches to the SSSG 0.

PDCCH monitoring based on a search space set belonging to an SSSG means PDCCH monitoring based on a type 3 common search space set and a user equipment-specific search space set that belong to an SSSG. Correspondingly, grouping the plurality of search space sets means grouping the type 3 common search space set and the user equipment-specific search space set.

Therefore, the terminal device switches the SSSG to perform PDCCH monitoring only based on some search space sets in an active downlink BWP, to reduce power consumption.

A plurality of different monitoring behaviors, for example, is a first candidate monitoring behavior to a fifth candidate monitoring behavior in the following, for PDCCH monitoring by the terminal device is defined based on the mechanism of skipping PDCCH monitoring and the search space set group switching mechanism.

First candidate monitoring behavior: The PDCCH is monitored based on a configured search space set. Specifically, the PDCCH is monitored based on configuration information of the search space set, where the configuration information of the search space set includes a PDCCH monitoring periodicity. The mechanism of skipping PDCCH monitoring is not activated or is not applied. In response to no search space set group in the active downlink BWP being configured for the terminal device, the terminal device performs PDCCH monitoring based on the configured search space set in the active downlink BWP. In response to a search space set group in the active downlink BWP being configured for the terminal device, the terminal device performs PDCCH monitoring based on a search space set that belongs to a current SSSG.

Second candidate monitoring behavior: PDCCH monitoring is skipped (or stopped) in skipped duration (skipped duration), namely, the mechanism of skipping PDCCH monitoring.

Third candidate monitoring behavior: The PDCCH is monitored based on the search space set belonging to the SSSG 0. Specifically, monitoring of the PDCCH based on the search space set of the SSSG 1 and the search space set of the SSSG 2 (if the SSSG 2 exists) is stopped.

Fourth candidate monitoring behavior: The PDCCH is monitored based on the search space set belonging to the SSSG 1. Specifically, monitoring of the PDCCH based on the search space set of the SSSG 0 and the search space set of the SSSG 2 (if the SSSG 2 exists) is stopped.

Fifth candidate monitoring behavior: The PDCCH is monitored based on the search space set belonging to the SSSG 2. Specifically, monitoring of the PDCCH based on the search space set of the SSSG 0 and the search space set of the SSSG 1 is stopped.

In some examples, the first candidate monitoring behavior is represented as a behavior 1, the second candidate monitoring behavior is represented as a behavior 1A, the third candidate monitoring behavior is represented as a behavior 2, the fourth candidate monitoring behavior is represented as a behavior 2A, and the fifth candidate monitoring behavior is represented as a behavior 2B.

The terminal device performs PDCCH monitoring based on one of the first candidate monitoring behavior to the fifth candidate monitoring behavior. However, currently, there is no effective solution to indicate how the terminal device determines a specific monitoring behavior. In response to the five candidate monitoring behaviors being randomly indicated, implementation complexity of the terminal device increases, and no additional benefit is brought.

In view of this, at least one embodiment provides a solution in which a network device configures a monitoring combination for a terminal device. The terminal device determines a monitoring behavior based on a configured monitoring combination indication, to effectively reduce power consumption of the terminal device and reduce implementation complexity of the terminal device.

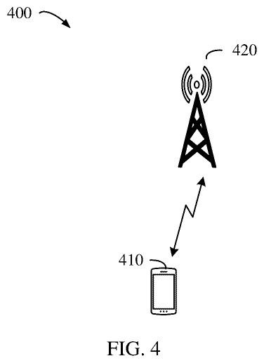

FIG. 4 is a schematic diagram of a communication system 400 in which an at least one embodiment is implemented. The system 400 shown in FIG. 4 includes a terminal device 410 and a network device 420. The terminal device 410 communicates with the network device 420.

FIG. 4 is merely an example. A type of the terminal device 410, a type of the network device 420, a communication protocol used by the communication system 400, and the like are not limited in at least one embodiment. The following describes embodiments with reference to the communication system 400 shown in FIG. 4.

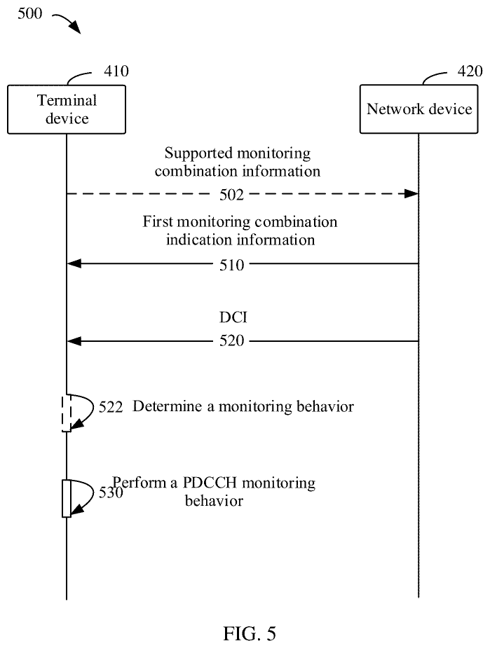

FIG. 5 is a diagram of signaling interaction of a process 500 between the terminal device 410 and the network device 420 according to at least one embodiment.

The network device 420 sends 510 first indication information for monitoring combination to the terminal device 410, where the first indication information for monitoring combination indicates at least two candidate monitoring behaviors.

The candidate monitoring behaviors related to at least one embodiment include a first candidate monitoring behavior, a second candidate monitoring behavior, a third candidate monitoring behavior, a fourth candidate monitoring behavior, and a fifth candidate monitoring behavior. The first candidate monitoring behavior indicates to perform PDCCH monitoring based on a configured search space set, the second candidate monitoring behavior indicates to stop PDCCH monitoring within preset duration, the third candidate monitoring behavior indicates to perform PDCCH monitoring based on a search space set in a first search space set group, the fourth candidate monitoring behavior indicates to perform PDCCH monitoring based on a search space set in a second search space set group, and the fifth candidate monitoring behavior indicates to perform PDCCH monitoring based on a search space set in a third search space set group.

Specifically, a monitoring combination indicated by the first indication information for monitoring combination is one of the following: a first monitoring combination, a second monitoring combination, a third monitoring combination, a fourth monitoring combination, or a fifth monitoring combination. In another example, a monitoring combination indicated by the first indication information for monitoring combination is one of the following: a first monitoring combination, a second monitoring combination, a fourth monitoring combination, or a fifth monitoring combination.

The first monitoring combination includes the first candidate monitoring behavior and the second candidate monitoring behavior. The second monitoring combination includes the second candidate monitoring behavior, the third candidate monitoring behavior, and the fourth candidate monitoring behavior. The third monitoring combination includes the second candidate monitoring behavior, the third candidate monitoring behavior, the fourth candidate monitoring behavior, and the fifth candidate monitoring behavior. The fourth monitoring combination includes the third candidate monitoring behavior and the fourth candidate monitoring behavior. The fifth monitoring combination includes the third candidate monitoring behavior, the fourth candidate monitoring behavior, and the fifth candidate monitoring behavior.

In at least one embodiment, the network device 420 explicitly or implicitly indicates the first monitoring combination, the second monitoring combination, the third monitoring combination, the fourth monitoring combination, or the fifth monitoring combination to the terminal device 410 by using RRC signaling.

Specifically, the network device 420 configures the first indication information for monitoring combination based on a mechanism of skipping PDCCH monitoring and a search space set group switching mechanism. For example, in response to no search space set group in an active downlink BWP being configured for the terminal device 410, the at least two candidate monitoring behaviors indicated by the first indication information for monitoring combination do not include the third candidate monitoring behavior, the fourth candidate monitoring behavior, and the fifth candidate monitoring behavior. In response to search space sets in the active downlink BWP being grouped into two groups, the at least two candidate monitoring behaviors indicated by the first indication information for monitoring combination do not include the fifth candidate monitoring behavior.

In some embodiments, a specific parameter of the RRC signaling is used as the first indication information for monitoring combination to indicate any one of the first monitoring combination, the second monitoring combination, the third monitoring combination, the fourth monitoring combination, or the fifth monitoring combination.

For example, the specific parameter is a PDCCH monitoring adaptation (PdcchMonitorAdaptation) parameter, and the network device 420 indicates the monitoring combination by using PdcchMonitorAdaptation. For example, the parameter is as follows:

PdcchMonitorAdaptation ENUMERATED {Beh 1and1A,
Beh 1Aand2and2A, Beh
1Aand2and2Aand2B, Beh 2and2A, Beh 2and2Aand2B}

“ENUMERATED” indicates enumeration. “Beh 1and1A” indicates the first monitoring combination including the first candidate monitoring behavior and the second candidate monitoring behavior. “Beh 1Aand2and2A” indicates the second monitoring combination including the second candidate monitoring behavior, the third candidate monitoring behavior, and the fourth candidate monitoring behavior. “Beh 1Aand2and2Aand2B” indicates the third monitoring combination including the second candidate monitoring behavior, the third candidate monitoring behavior, the fourth candidate monitoring behavior, and the fifth candidate monitoring behavior. “Beh 2and2A” indicates the fourth monitoring combination including the third candidate monitoring behavior and the fourth candidate monitoring behavior. “Beh 2and2Aand2B” indicates the fifth monitoring combination including the third candidate monitoring behavior, the fourth candidate monitoring behavior, and the fifth candidate monitoring behavior.

For example, the specific parameter is included in an information element (Information Element, IE) of RRC, for example, included in PDCCH-Config, included in BWP-DownlinkDedicated, or included in ServingCellConfig.

Optionally, in response to the at least two candidate monitoring behaviors including the second candidate monitoring behavior, the network device 420 further configures skipped duration. For example, the network device 420 sends indication information of preset duration to the terminal device 410, so that the terminal device 410 stops PDCCH monitoring in the preset duration. The indication information of the preset duration is included in PDCCH-Config, or is independent of PDCCH-Config. This is not limited in at least one embodiment. A time unit of the preset duration is a second, a millisecond, a frame, a subframe, a slot, a quantity of PDCCH monitoring occasions, a slot set including several consecutive slots, or the like. This is not limited in at least one embodiment.

In some embodiments, the RRC signaling directly configures the at least two candidate monitoring behaviors through enumeration, for example, configures the at least two candidate monitoring behaviors in a form of {parameter 1, parameter 2, . . . , parameter N}. Each parameter corresponds to one candidate monitoring behavior.

Specifically, {Beh 1, Beh 1A} indicates the first monitoring combination including the first candidate monitoring behavior and the second candidate monitoring behavior. {Beh 1A, Beh 2, Beh 2A} indicates the second monitoring combination including the second candidate monitoring behavior, the third candidate monitoring behavior, and the fourth candidate monitoring behavior. {Beh 1A, Beh 2, Beh 2A, Beh 2B} indicates the third monitoring combination including the second candidate monitoring behavior, the third candidate monitoring behavior, the fourth candidate monitoring behavior, and the fifth candidate monitoring behavior. {Beh 2, Beh 2A} indicates the fourth monitoring combination including the third candidate monitoring behavior and the fourth candidate monitoring behavior. {Beh 2, Beh 2A, Beh 2B} indicates the fifth monitoring combination including the third candidate monitoring behavior, the fourth candidate monitoring behavior, and the fifth candidate monitoring behavior.

In some embodiments, the network device 420 uses a combination of a first specific parameter and a second specific parameter of the RRC signaling to indicate any one of the first monitoring combination, the second monitoring combination, the third monitoring combination, the fourth monitoring combination, or the fifth monitoring combination.

For example, the first specific parameter is PDCCH monitoring adaptation (PdcchMonitorAdaptation), and the second specific parameter is a quantity of search space set groups (nrofSearchSpaceSetGroup). For example, the parameter is as follows:

| | |
|---|---|
| PdcchMonitorAdaptation | ENUMERATED {PdcchSkipping, |

PdcchSkippingAndSearchSpaceSetGroupSwitching,
SearchSpaceSetGroupSwitching }

| | |
|---|---|
| nrofSearchSpaceSetGroup | INTEGER (2,3) |

“ENUMERATED” indicates enumeration, and “INTEGER” indicates an integer.

Specifically, that PdcchMonitorAdaptation indicates “PdcchSkipping” indicates the first monitoring combination including the first candidate monitoring behavior and the second candidate monitoring behavior.

Specifically, that PdcchMonitorAdaptation indicates “PdcchSkippingAndSearchSpaceSetGroupSwitching” and nrofSearchSpaceSetGroup indicates “2” indicates the second monitoring combination including the second candidate monitoring behavior, the third candidate monitoring behavior, and the fourth candidate monitoring behavior. Optionally, that PdcchMonitorAdaptation indicates “PdcchSkippingAndSearchSpaceSetGroupSwitching” alternatively indicates the second monitoring combination including the second candidate monitoring behavior, the third candidate monitoring behavior, and the fourth candidate monitoring behavior.

Specifically, that PdcchMonitorAdaptation indicates “PdcchSkippingAndSearchSpaceSetGroupSwitching” and nrofSearchSpaceSetGroup indicates “3” indicates the third monitoring combination including the second candidate monitoring behavior, the third candidate monitoring behavior, the fourth candidate monitoring behavior, and the fifth candidate monitoring behavior.

Specifically, that PdcchMonitorAdaptation indicates “SearchSpaceSetGroupSwitching” and nrofSearchSpaceSetGroup indicates “2” indicates the fourth monitoring combination including the third candidate monitoring behavior and the fourth candidate monitoring behavior.

Specifically, that PdcchMonitorAdaptation indicates “SearchSpaceSetGroupSwitching” and nrofSearchSpaceSetGroup indicates “3” indicates the fifth monitoring combination including the third candidate monitoring behavior, the fourth candidate monitoring behavior, and the fifth candidate monitoring behavior.

Optionally, in response to the at least two candidate monitoring behaviors including the second candidate monitoring behavior, the network device 420 further configures skipped duration. For example, the network device 420 sends indication information of preset duration to the terminal device 410, so that the terminal device 410 stops monitoring the PDCCH in the preset duration. The indication information of the preset duration is included in PDCCH-Config, or is independent of PDCCH-Config (for example, sending by using other configuration information). This is not limited in at least one embodiment. A time unit of the preset duration is a second, a millisecond, a frame, a subframe, a slot, a quantity of PDCCH monitoring occasions, a slot set including several consecutive slots, or the like. This is not limited in at least one embodiment.

In some embodiments, the network device 420 uses a combination of a third specific parameter and a fourth specific parameter of the RRC signaling to indicate any one of the first monitoring combination, the second monitoring combination, the third monitoring combination, the fourth monitoring combination, or the fifth monitoring combination.

For example, the third specific parameter indicates skipped duration in which PDCCH monitoring is stopped. The third specific parameter is included in PDCCH-Config, or is independent of PDCCH-Config. This is not limited in at least one embodiment.

For example, the fourth specific parameter indicates an index of an SSSG to which the search space set belongs, where the index is at least one of 0, 1, or 2. The fourth specific parameter is included in the configuration information of the search space set. A search space set SS set 1 is used as an example. Configuration information of the search space set includes the fourth specific parameter, and the fourth specific parameter indicates an index of an SSSG to which the search space set belongs.

Specifically, the network device 420 configures the third specific parameter and does not configure the fourth specific parameter, to indicate the first monitoring combination including the first candidate monitoring behavior and the second candidate monitoring behavior. The network device 420 configures the third specific parameter and the fourth specific parameter, and the fourth specific parameter has two types: 0 and 1, to indicate the second monitoring combination including the second candidate monitoring behavior, the third candidate monitoring behavior, and the fourth candidate monitoring behavior. The network device 420 configures the third specific parameter and the fourth specific parameter, and the fourth specific parameter has three types: 0, 1, and 2, to indicate the third monitoring combination including the second candidate monitoring behavior, the third candidate monitoring behavior, the fourth candidate monitoring behavior, and the fifth candidate monitoring behavior. The network device 420 configures the fourth specific parameter and does not configure the third specific parameter, and the fourth specific parameter has two types: 0 and 1, to indicate the fourth monitoring combination including the third candidate monitoring behavior and the fourth candidate monitoring behavior. The network device 420 configures the fourth specific parameter and does not configure the third specific parameter, and the fourth specific parameter has three types: 0, 1, and 2, to indicate the fifth monitoring combination including the third candidate monitoring behavior, the fourth candidate monitoring behavior, and the fifth candidate monitoring behavior.

Additionally or optionally, the network device 420 further sends the configuration information of the search space set to the terminal device 410. The configuration information of the search space set includes at least one of the following: identification information of the search space set, a control resource set associated with the search space set, a PDCCH monitoring periodicity and offset, a PDCCH monitoring pattern within a slot, duration, an aggregation level and a quantity of PDCCH candidates corresponding to each aggregation level, search space set type indication information, and the like.

Optionally, in some at least one embodiment, the first indication information for monitoring combination indicates a monitoring combination of a first BWP. In addition, the network device 420 further sends second indication information for monitoring combination to the terminal device 410. The second indication information for monitoring combination indicates a monitoring combination of a second BWP. The first indication information for monitoring combination indicates one of the following: the first monitoring combination, the second monitoring combination, the third monitoring combination, the fourth monitoring combination, or the fifth monitoring combination. The second indication information for monitoring combination indicates one of the following: the first monitoring combination, the second monitoring combination, the third monitoring combination, the fourth monitoring combination, or the fifth monitoring combination. Although two BWPs are used as an example for description herein, this is also applicable to a case of more BWPs. For example, a monitoring combination of a respective BWP is indicated for each BWP. Correspondingly, the first candidate monitoring behavior indicates to perform PDCCH monitoring based on a configured search space set in the active downlink BWP, the second candidate monitoring behavior indicates to stop PDCCH monitoring within preset duration in the active downlink BWP, the third candidate monitoring behavior indicates to perform PDCCH monitoring based on a search space set in a first search space set group in the active downlink BWP, the fourth candidate monitoring behavior indicates to perform PDCCH monitoring based on a search space set in a second search space set group in the active downlink BWP, and the fifth candidate monitoring behavior indicates to perform PDCCH monitoring based on a search space set in a third search space set group in the active downlink BWP.

In response to a plurality of BWPs being configured for the terminal device 410, monitoring combinations are separately configured for different BWPs. In addition, monitoring combinations configured for different BWPs is the same or different. For example, the network device 420 configures a same monitoring combination for a plurality of BWPs that belong to a same cell.

Optionally, in some at least one embodiment, the first indication information for monitoring combination indicates a monitoring combination of a first cell. In addition, the network device 420 further sends third indication information for monitoring combination to the terminal device 410. The third indication information for monitoring combination indicates a monitoring combination of a second cell. In response to a plurality of cells being configured for the terminal device 410, monitoring combinations is separately configured for different cells. In addition, monitoring combinations configured for different cells are the same or different. For example, the network device 420 configures a same monitoring combination for a plurality of cells that belong to a same cell group.

Optionally, in some at least one embodiment, the first indication information for monitoring combination indicates a monitoring combination of a first cell group. In addition, the network device 420 further sends fourth indication information for monitoring combination to the terminal device 410. The fourth indication information for monitoring combination indicates a monitoring combination of a second cell group. In response to a plurality of cell groups being configured for the terminal device 410, monitoring combinations are separately configured for different cell groups. In addition, monitoring combinations configured for different cell groups is the same or different.

As shown in FIG. 5, additionally or optionally, the terminal device 410 sends 502 supported monitoring combination information to the network device 420.

Specifically, the supported monitoring combination information indicates a monitoring combination supported by the terminal device 410. The monitoring combination supported by the terminal device 410 includes at least one of the first monitoring combination, the second monitoring combination, the third monitoring combination, the fourth monitoring combination, and the fifth monitoring combination. In addition, correspondingly, a candidate monitoring behavior in the monitoring combination indicated by the first indication information for monitoring combination sent by the network device 420 is a subset or a universal set of candidate monitoring behaviors in the monitoring combination supported by the terminal device 410. The supported monitoring combination information is included in UE capability information or UE assistance information. In another example, the monitoring combination supported by the terminal device 410 includes at least one of the first monitoring combination, the second monitoring combination, the fourth monitoring combination, and the fifth monitoring combination.

In some embodiments, the monitoring combination supported by the terminal device 410 is indicated by using a first parameter in the UE capability information or the UE assistance information. For example, the first parameter is supported PDCCH monitoring adaptation (supportedPdcchMonitoringAdaptation), for example, the parameter is as follows:

supportedPdcchMonitoringAdaptation ENUMERATED
{Beh 1and1A, Beh 2and2A, Beh
2and2Aand2B, Beh 1Aand2and2A, Beh 1Aand2and2Aand2B}

“ENUMERATED” indicates enumeration. “Beh 1and1A” indicates the first monitoring combination including the first candidate monitoring behavior and the second candidate monitoring behavior. “Beh 1Aand2and2A” indicates the second monitoring combination including the second candidate monitoring behavior, the third candidate monitoring behavior, and the fourth candidate monitoring behavior. “Beh 1Aand2and2Aand2B” indicates the third monitoring combination including the second candidate monitoring behavior, the third candidate monitoring behavior, the fourth candidate monitoring behavior, and the fifth candidate monitoring behavior. “Beh 2and2A” indicates the fourth monitoring combination including the third candidate monitoring behavior and the fourth candidate monitoring behavior. “Beh 2and2Aand2B” indicates the fifth monitoring combination including the third candidate monitoring behavior, the fourth candidate monitoring behavior, and the fifth candidate monitoring behavior.

In some embodiments, the UE capability information or the UE assistance information directly indicates, through enumeration, the monitoring combination supported by the terminal device 410, for example, configures the monitoring combination in a form of {parameter 1, parameter 2, . . . , parameter N}. Each parameter corresponds to one candidate monitoring behavior.

Specifically, {Beh 1, Beh 1A} indicates the first monitoring combination including the first candidate monitoring behavior and the second candidate monitoring behavior. {Beh TA, Beh 2, Beh 2A} indicates the second monitoring combination including the second candidate monitoring behavior, the third candidate monitoring behavior, and the fourth candidate monitoring behavior. {Beh TA, Beh 2, Beh 2A, Beh 2B} indicates the third monitoring combination including the second candidate monitoring behavior, the third candidate monitoring behavior, the fourth candidate monitoring behavior, and the fifth candidate monitoring behavior. {Beh 2, Beh 2A} indicates the fourth monitoring combination including the third candidate monitoring behavior and the fourth candidate monitoring behavior. {Beh 2, Beh 2A, Beh 2B} indicates the fifth monitoring combination including the third candidate monitoring behavior, the fourth candidate monitoring behavior, and the fifth candidate monitoring behavior.

In some embodiments, the monitoring combination supported by the terminal device 410 is indicated by using a combination of a second parameter and a third parameter in the UE capability information or the UE assistance information. For example, the second parameter is supported PDCCH monitoring adaptation (supportedPdcchMonitoringAdaptation), and the third parameter is a quantity of supported search space set groups (supportedNrofSearchSpaceSetGroup). For example, the parameter is as follows:

| PdcchMonitoringAdaptation ::= SEQUENCE { | |
|---|---|
| supportedPdcchMonitoringAdaptation | ENUMERATED |
| | {PdcchSkipping, |
| SearchSpaceSetGroupSwitching, | |
| PdcchSkippingAndSearchSpaceSetGroupSwitching} | |
| supportedNrofSearchSpaceSetGroup | INTEGER (2,3) |

}

“ENUMERATED” indicates enumeration, and “INTEGER” indicates an integer.

Specifically, that supportedPdcchMonitoringAdaptation indicates “PdcchSkipping” indicates the first monitoring combination including the first candidate monitoring behavior and the second candidate monitoring behavior.

Specifically, that supportedPdcchMonitoringAdaptation indicates “PdcchSkippingAndSearchSpaceSetGroupSwitching” and supportedNrofSearchSpaceSetGroup indicates “2” indicates the second monitoring combination including the second candidate monitoring behavior, the third candidate monitoring behavior, and the fourth candidate monitoring behavior. Optionally, that supportedPdcchMonitoringAdaptation indicates “PdcchSkippingAndSearchSpaceSetGroupSwitching” indicates the second monitoring combination including the second candidate monitoring behavior, the third candidate monitoring behavior, and the fourth candidate monitoring behavior.

Specifically, that supportedPdcchMonitoringAdaptation indicates “PdcchSkippingAndSearchSpaceSetGroupSwitching” and supportedNrofSearchSpaceSetGroup indicates “3” indicates the third monitoring combination including the second candidate monitoring behavior, the third candidate monitoring behavior, the fourth candidate monitoring behavior, and the fifth candidate monitoring behavior.

Specifically, that supportedPdcchMonitoringAdaptation indicates “SearchSpaceSetGroupSwitching” and supportedNrofSearchSpaceSetGroup indicates “2” indicates the fourth monitoring combination including the third candidate monitoring behavior and the fourth candidate monitoring behavior.

Specifically, that supportedPdcchMonitoringAdaptation indicates “SearchSpaceSetGroupSwitching” and supportedNrofSearchSpaceSetGroup indicates “3” indicates the fifth monitoring combination including the third candidate monitoring behavior, the fourth candidate monitoring behavior, and the fifth candidate monitoring behavior.

The network device 420 determines the first indication information for monitoring combination based on the supported monitoring combination information from the terminal device 410. Then, the network device 420 sends the first indication information for monitoring combination to the terminal device 410 by using the RRC signaling. For example, one monitoring combination is selected from the monitoring combinations indicated by the supported monitoring combination information, and the first indication information for monitoring combination indicates the selected monitoring combination.

In the process 500, the network device 420 sends 520 the DCI to the terminal device 410.

Specifically, the terminal device 410 determines a PDCCH monitoring occasion based on the configuration information of the search space set, and further performs PDCCH monitoring on the determined PDCCH monitoring occasion. On a PDCCH monitoring occasion, the terminal device 410 obtains the DCI from the network device 420 through monitoring. The DCI is carried on the PDCCH.

The DCI indicates the monitoring behavior of the terminal device 410, and the indicated monitoring behavior belongs to one of the at least two candidate monitoring behaviors included in the first indication information for monitoring combination.

In the process 500, the terminal device 410 performs 530 PDCCH monitoring behavior based on the first indication information for monitoring combination and the DCI.

Additionally or optionally, the terminal device 410 determines 522 the monitoring behavior from the at least two candidate monitoring behaviors based on the first indication information for monitoring combination and the DCI.

The monitoring combination indicated by the first indication information for monitoring combination includes the at least two candidate monitoring behaviors. A candidate monitoring behavior corresponding to a value of the DCI is selected from the at least two candidate monitoring behaviors based on the specific value of the DCI.

In at least one embodiment, the DCI has a preset quantity of bits. For example, the preset quantity of bits is 1 bit, 2 bits, or more bits. For example, the preset quantity of bits is 2 bits. The DCI has four different values: 00, 01, 10, and 11. The 2 bits are two consecutive bits in the DCI, for example, 2 bits in a same field, or two separated independent bits, for example, two independent fields each have 1 bit. Then, the four different values are understood as values indicated by two separated independent bits.

In some embodiments, the monitoring behavior is determined by using an example shown in Table 2. For example, in response to the first indication information for monitoring combination indicating the second monitoring combination and the DCI is a first value, the monitoring behavior is determined as the second candidate monitoring behavior. In response to the first indication information for monitoring combination indicating the fifth monitoring combination and the DCI is a second value, the monitoring behavior is determined as the fourth candidate monitoring behavior. Optionally, in response to the first indication information for monitoring combination indicating the first monitoring combination, and the DCI is any one of the second value, a third value, or a fourth value, the monitoring behavior is determined as the first candidate monitoring behavior. The first value, the second value, the third value, and the fourth value shown in Table 2 are not equal to each other. In an example, the first value is 00, the second value is 01, the third value is 10, and the fourth value is 11. However, a person skilled in the art understands that this is merely an example. In view of this, another different example is obtained, and still falls within the protection scope of embodiments described herein.

TABLE 2
Monitoring

| combination | | | | |
|---|---|---|---|---|
| indicated | | | | |
| by first | | | | |
| indication | Monitoring behavior | | | |
| information | DCI | DCI | DCI | DCI |
| for | is a | is a | is a | is a |
| monitoring | first | second | third | fourth |
| combination | value | value | value | value |
| First | Second | First | | |
| monitoring | candidate | candidate | | |
| combination | monitoring | monitoring | | |
| | behavior | behavior | | |
| Second | Second | Third | Fourth | |
| monitoring | candidate | candidate | candidate | |
| combination | monitoring | monitoring | monitoring | |
| | behavior | behavior | behavior | |
| Third | Second | Third | Fourth | Fifth |
| monitoring | candidate | candidate | candidate | candidate |
| combination | monitoring | monitoring | monitoring | monitoring |
| | behavior | behavior | behavior | behavior |
| Fourth | Third | Fourth | | |
| monitoring | candidate | candidate | | |
| combination | monitoring | monitoring | | |
| | behavior | behavior | | |
| Fifth | Third | Fourth | Fifth | |
| monitoring | candidate | candidate | candidate | |
| combination | monitoring | monitoring | monitoring | |
| | behavior | behavior | behavior | |

Table 2 shows only an example of at least one embodiment. For another example, in response to the first indication information for monitoring combination indicating the first monitoring combination, the DCI is the first value to indicate the second candidate monitoring behavior, and the DCI is the second value to indicate the first candidate monitoring behavior. Alternatively, the DCI is the second value to indicate the second candidate monitoring behavior, and the DCI is the first value to indicate the first candidate monitoring behavior. Alternatively, the DCI is the third value to indicate the second candidate monitoring behavior, the DCI is the fourth value to indicate the first candidate monitoring behavior, and the like. Examples are not enumerated herein.

In some other embodiments, in response to the determined monitoring behavior being the second candidate monitoring behavior, fixed preset duration (that is, skipped duration) is used, or a plurality of different pieces of preset duration is used. An example is shown in Table 3.

TABLE 3
Monitoring

| combination | | | | |
|---|---|---|---|---|
| indicated | | | | |
| by first | | | | |
| indication | Monitoring behavior | | | |
| information | DCI | DCI | DCI | DCI |
| for | is a | is a | is a | is a |
| monitoring | first | second | third | fourth |
| combination | value | value | value | value |
| First | First | Second | Second | Second |
| monitoring | candidate | candidate | candidate | candidate |
| combination | monitoring | monitoring | monitoring | monitoring |
| | behavior | behavior | behavior | behavior |
| | | (first | (second | (third |
| | | preset | preset | preset |
| | | duration) | duration) | duration) |
| Second | Third | Fourth | Second | Second |
| monitoring | candidate | candidate | candidate | candidate |
| combination | monitoring | monitoring | monitoring | monitoring |
| | behavior | behavior | behavior | behavior |
| | | | (first | (second |
| | | | preset | preset |
| | | | duration) | duration) |

Table 3 shows only a case in which the first indication information for monitoring combination indicates the first monitoring combination or the second monitoring combination. For another case, refer to Table 2. Table 3 is merely an example. Various variations i-Rare made according to Table 3 to obtain other embodiments.

In some other embodiments, the monitoring behavior is determined according to a one-to-one correspondence between the value of the DCI and locations or indexes of the at least two candidate monitoring behaviors in the RRC signaling. In some embodiments, the RRC signaling configures the at least two candidate monitoring behaviors through enumeration. For example, in response to the at least two candidate monitoring behaviors configured in the RRC signaling being {Beh 1A, Beh 2, Beh 2A}, that the DCI is the first value corresponding to a candidate monitoring behavior of a first index, namely, the second candidate monitoring behavior Beh 1A. That the DCI is the second value corresponds to a candidate monitoring behavior of a second index, namely, the third candidate monitoring behavior Beh 2. That the DCI is the third value corresponds to a candidate monitoring behavior of a third index, namely, the fourth candidate monitoring behavior Beh 2A. In an example, the monitoring behavior is determined according to a one-to-many correspondence between the value of the DCI and locations or indexes of the at least two candidate monitoring behaviors in the RRC signaling. For example, in response to the at least two candidate monitoring behaviors configured in the RRC signaling being {Beh 1A, Beh 2, Beh 2A}, that the DCI is the first value corresponding to a candidate monitoring behavior of a first index, namely, the second candidate monitoring behavior Beh 1A, and the first preset duration is used. That the DCI is the second value corresponds to the candidate monitoring behavior of the first index, namely, the second candidate monitoring behavior Beh 1A, and the second preset duration is used. That the DCI is the third value corresponds to a candidate monitoring behavior of a second index, namely, the third candidate monitoring behavior Beh 2. That the DCI is the fourth value corresponds to a candidate monitoring behavior of a third index, namely, the fourth candidate monitoring behavior Beh 2A.

The monitoring behavior determined by the terminal device 410 is used for a type 3 common search space set and a terminal device-specific search space set. For example, the monitoring behavior is the second candidate monitoring behavior, monitoring is stopped in preset duration for the type 3 common search space set and the terminal device-specific search space set, and the PDCCH is monitored after the preset duration. For another type of common search space set, for example, type 0, type 0A, type 1, and type 2 common search space sets, the terminal device 410 skips or does not skip PDCCH monitoring with DCI scrambled by a C-RNTI, an MCS-C-RNTI, or a CS-RNTI. This is not limited in at least one embodiment. For the type 0, type 0A, type 1, and type 2 common search space sets, whether the terminal device performs PDCCH monitoring with DCI scrambled by an SI-RNTI, an RA-RNTI, a TC-RNTI, or a P-RNTI is not limited in at least one embodiment.

In response to the terminal device 410 being configured with a plurality of BWPs, and monitoring combinations are separately configured for different BWPs, the DCI further indicates a BWP identifier (ID). The terminal device 410 determines the monitoring behavior based on the monitoring combination of the BWP corresponding to the BWP ID and the foregoing embodiment.

In this way, in at least one embodiment, the network device configures the monitoring combination for the terminal device, and then the terminal device determines the monitoring behavior based on the configured monitoring combination and the DCI from the network device. The terminal device performs the monitoring behavior, to reduce unnecessary PDCCH monitoring. This greatly reduces power consumption. In addition, based on the monitoring combination configuration manner in at least one embodiment, an appropriate combination of a plurality of monitoring behaviors is implemented, and implementation complexity of the terminal device is reduced.

In at least one embodiment, “first”, “second”, “third”, and the like are only intended to indicate that a plurality of objects is different, but two objects are the same. The “first”, “second”, “third”, and the like should not be construed as a limitation on at least one embodiment.

Division into the manners, cases, categories, and embodiments in at least one embodiment is only intended for ease of description, and should not constitute a particular limitation. The features in the manners, categories, cases, and embodiments are combined with each other in response to being logical.

The foregoing content is only intended to help a person skilled in the art better understand at least one embodiment, instead of limiting the scope of at least one embodiment. A person skilled in the art is able to make various modifications, changes, combinations, or the like based on the foregoing content. A modified, changed, or combined solution also falls within the scope of at least one embodiment.

The descriptions of the foregoing content focus on emphasizing a difference between the embodiments, and for the same or similar content of the embodiments, refer to each other. For simplicity, details are not further described herein.

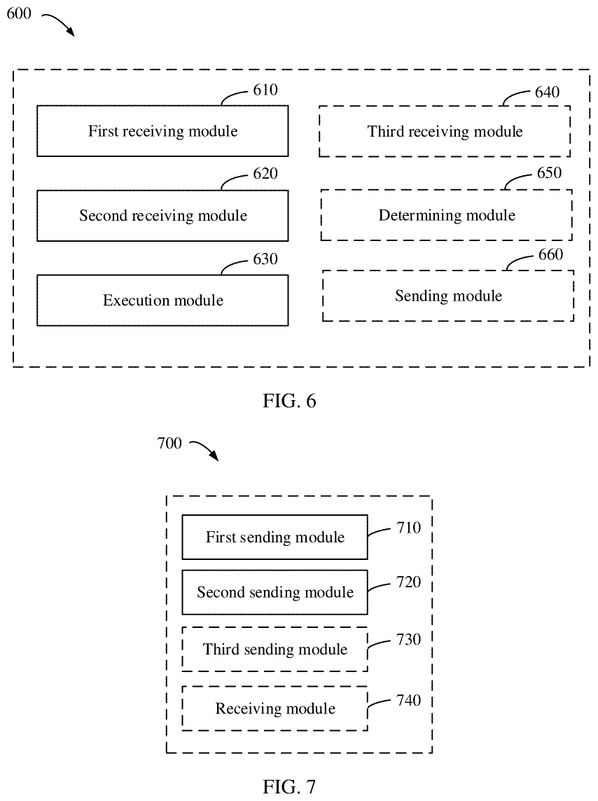

FIG. 6 is a schematic block diagram of a communication apparatus 600 for information transmission according to at least one embodiment. The apparatus 600 is implemented as the terminal device 410, a part (for example, a chip) of the terminal device 410, or the like. This is not limited in at least one embodiment.

As shown in FIG. 6, the apparatus 600 includes a first receiving module 610, a second receiving module 620, and an execution module 630. The first receiving module 610 is configured to receive first indication information for monitoring combination from a network device, where the first indication information for monitoring combination indicates at least two candidate monitoring behaviors. The second receiving module 620 is configured to receive downlink control information DCI from the network device, where the DCI indicates a monitoring behavior of the communication apparatus, and the monitoring behavior is one of the at least two candidate monitoring behaviors. The execution module 630 is configured to perform a downlink control channel (e.g. PDCCH) monitoring behavior based on the first indication information for monitoring combination and the DCI.

Specifically, in some embodiments, the first receiving module 610 is configured to receive the first indication information for monitoring combination from the network device. The first indication information for monitoring combination indicates one of the following: a first monitoring combination, including a first candidate monitoring behavior and a second candidate monitoring behavior; a second monitoring combination, including the second candidate monitoring behavior, a third candidate monitoring behavior, and a fourth candidate monitoring behavior; a third monitoring combination, including the second candidate monitoring behavior, the third candidate monitoring behavior, the fourth candidate monitoring behavior, and a fifth candidate monitoring behavior; a fourth monitoring combination, including the third candidate monitoring behavior and the fourth candidate monitoring behavior; or a fifth monitoring combination, including the third candidate monitoring behavior, the fourth candidate monitoring behavior, and the fifth candidate monitoring behavior. The first candidate monitoring behavior indicates to perform PDCCH monitoring based on a configured search space set, the second candidate monitoring behavior indicates to stop PDCCH monitoring within preset duration, the third candidate monitoring behavior indicates to perform PDCCH monitoring based on a search space set in a first search space set group, the fourth candidate monitoring behavior indicates to perform PDCCH monitoring based on a search space set in a second search space set group, and the fifth candidate monitoring behavior indicates to perform PDCCH monitoring based on a search space set in a third search space set group.

In response to the first indication information for monitoring combination indicating the first monitoring combination, the second monitoring combination, or the third monitoring combination, the apparatus 600 further includes a third receiving module 640, configured to receive indication information of the preset duration from the network device.

Additionally or optionally, the apparatus 600 further includes a determining module 650, configured to determine the monitoring behavior from the at least two candidate monitoring behaviors based on the DCI.

In some embodiments, the first indication information for monitoring combination indicates a monitoring combination of a first bandwidth part BWP, and the first receiving module 610 is further configured to receive second indication information for monitoring combination from the network device, where the second indication information for monitoring combination indicates a monitoring combination of a second BWP. Optionally, the monitoring combination of the first BWP is the same as the monitoring combination of the second BWP.

In some embodiments, the first indication information for monitoring combination indicates a monitoring combination of a first cell, and the first receiving module 610 is further configured to receive third indication information for monitoring combination from the network device, where the third indication information for monitoring combination indicates a monitoring combination of a second cell. Optionally, the monitoring combination of the first cell is the same as the monitoring combination of the second cell.

As shown in FIG. 6, the apparatus 600 further includes a sending module 660, configured to send supported monitoring combination information to the network device, where the supported monitoring combination information indicates a monitoring combination supported by the communication apparatus.

In some embodiments, the monitoring behavior performed by the execution module 630 is used for a type 3 common search space set and a terminal device-specific search space set.

Division into modules or units in at least one embodiment is an example, is merely logical function division, and is another division manner during actual implementation. In addition, functional modules in at least one embodiment are integrated into one unit, or exist alone physically, or two or more units are integrated into one unit. The integrated unit is implemented in a form of hardware, or is implemented in a form of a software functional unit.

The apparatus 600 in FIG. 6 is configured to implement the foregoing processes performed by the terminal device 410 with reference to FIG. 5. For brevity, details are not described herein again.

FIG. 7 is a schematic block diagram of a communication apparatus 700 for information transmission according to at least one embodiment. The apparatus 700 is implemented as the network device 420, a part (for example, a chip) of the network device 420, or the like. This is not limited in at least one embodiment.

As shown in FIG. 7, the apparatus 700 includes a first sending module 710 and a second sending module 720. The first sending module 710 is configured to send first indication information for monitoring combination to a terminal device, where the first indication information for monitoring combination indicates at least two candidate monitoring behaviors. The second sending module 720 is configured to send downlink control information DCI to the terminal device, so that the terminal device performs a downlink control channel (e.g. PDCCH) monitoring behavior based on the first indication information for monitoring combination and the DCI, where the monitoring behavior is one of the at least two candidate monitoring behaviors.

Specifically, in some embodiments, the first sending module 710 is configured to send the first indication information for monitoring combination to the terminal device. The first indication information for monitoring combination indicates one of the following: a first monitoring combination, including a first candidate monitoring behavior and a second candidate monitoring behavior; a second monitoring combination, including the second candidate monitoring behavior, a third candidate monitoring behavior, and a fourth candidate monitoring behavior; a third monitoring combination, including the second candidate monitoring behavior, the third candidate monitoring behavior, the fourth candidate monitoring behavior, and a fifth candidate monitoring behavior; a fourth monitoring combination, including the third candidate monitoring behavior and the fourth candidate monitoring behavior; or a fifth monitoring combination, including the third candidate monitoring behavior, the fourth candidate monitoring behavior, and the fifth candidate monitoring behavior. The first candidate monitoring behavior indicates to perform PDCCH monitoring based on a configured search space set, the second candidate monitoring behavior indicates to stop PDCCH monitoring within preset duration, the third candidate monitoring behavior indicates to perform PDCCH monitoring based on a search space set in a first search space set group, the fourth candidate monitoring behavior indicates to perform PDCCH monitoring based on a search space set in a second search space set group, and the fifth candidate monitoring behavior indicates to perform PDCCH monitoring based on a search space set in a third search space set group.

In response to the first indication information for monitoring combination indicating the first monitoring combination, the second monitoring combination, or the third monitoring combination, the apparatus 700 further includes a third sending module 730, configured to send indication information of the preset duration to the terminal device.

In some embodiments, the first indication information for monitoring combination indicates a monitoring combination of a first bandwidth part BWP, and the first sending module 710 is further configured to send a second indication information for monitoring combination to the terminal device, where the second indication information for monitoring combination indicates a monitoring combination of a second BWP. Optionally, the monitoring combination of the first BWP is the same as the monitoring combination of the second BWP.

In some embodiments, the first indication information for monitoring combination indicates a monitoring combination of a first cell, and the first sending module 710 is further configured to send a third indication information for monitoring combination to the terminal device, where the third indication information for monitoring combination indicates a monitoring combination of a second cell. Optionally, the monitoring combination of the first cell is the same as the monitoring combination of the second cell.

As shown in FIG. 7, the apparatus 700 further includes a receiving module 740, configured to receive supported monitoring combination information from the terminal device, where the supported monitoring combination information indicates a monitoring combination supported by the terminal device, and a monitoring combination indicated by the first indication information for monitoring combination belongs to the monitoring combination supported by the terminal device.

In some embodiments, the monitoring behavior is used for a type 3 common search space set and a terminal device-specific search space set.

Division into modules or units in at least one embodiment is an example, is merely logical function division, and is another division manner during actual implementation. In addition, functional modules in at least one embodiment are integrated into one unit, or exist alone physically, or two or more units are integrated into one unit. The integrated unit is implemented in a form of hardware, or is implemented in a form of a software functional unit.

The apparatus 700 in FIG. 7 is configured to implement the foregoing processes performed by the network device 420 with reference to FIG. 5. For brevity, details are not described herein again.

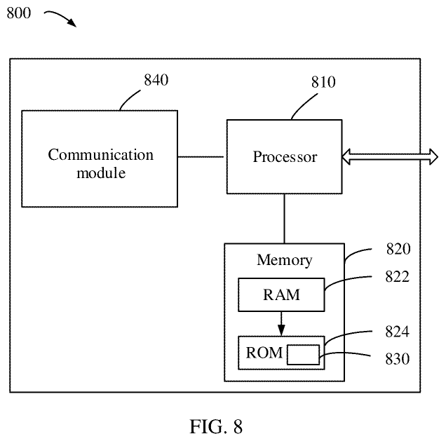

FIG. 8 is a schematic block diagram of an example device 800 that is used to implement an at least one embodiment. The device 800 is implemented or included in the terminal device 410 in FIG. 4, or is implemented or included in the network device 420 in FIG. 4. As shown in the figure, the device 800 includes one or more processors 810, one or more memories 820 coupled to the processor 810, and a communication module 840 coupled to the processor 810.

The communication module 840 is configured for bidirectional communication. The communication module 840 has at least one communication interface for communication. The communication interface includes any interface used for communicating with another device.

The processor 810 is of any type suitable for a local technology network, and includes but is not limited to at least one of the following: one or more of a general-purpose computer, a dedicated computer, a microcontroller, a digital signal processor (DSP), or a controller-based multi-core controller architecture. The device 800 has a plurality of processors, for example, an application-specific integrated circuit chip, which in time belongs to a clock synchronized with a main processor.

The memory 820 includes one or more non-volatile memories and one or more volatile memories. Examples of the non-volatile memory include but are not limited to at least one of the following: a read-only memory (ROM) 824, an erasable programmable read-only memory (EPROM), a flash memory, a hard disk, a compact disc (CD), a digital versatile disc (DVD) or other magnetic and/or optical storage. Examples of the volatile memory include but are not limited to at least one of the following: a random access memory (RAM) 822 or another volatile memory that does not last for power-off duration.

The computer program 830 includes computer-executable instructions executed by an association processor 810. A program 830 is stored in the ROM 824. The processor 810 performs any suitable action and processing by loading the program 830 into the RAM 822.

At least one embodiment is implemented by using the program 830, to enable the device 800 to perform any process discussed with reference to FIG. 4 to FIG. 6. Embodiments described herein are alternatively implemented by using hardware or a combination of software and hardware.

The program 830 is tangibly included in a computer-readable medium, and the computer-readable medium is included in the device 800 (for example, in the memory 820) or another storage device that is accessed by the device 800. The program 830 is loaded from the computer-readable medium into the RAM 822 for execution. The computer-readable medium includes any type of tangible nonvolatile memory, such as a ROM, an EPROM, a flash memory, a hard disk, a CD, or a DVD.

In some embodiments, the communication module 840 in the device 800 is implemented as a transmitter and a receiver (or a transceiver), and is configured to send/receive information such as first indication information for monitoring combination and monitoring combination information supported by the terminal device. In addition, the device 800 further includes one or more of a scheduler, a controller, and a radio frequency/antenna. Details are not described herein.

For example, the device 800 in FIG. 8 is implemented as an electronic device, or a chip or a chip system of the electronic device. This is not limited in at least one embodiment.

At least one embodiment further provides a chip. The chip includes an input interface, an output interface, and a processing circuit. In this at least one embodiment, the input interface and the output interface are configured to complete signaling or data exchange, and the processing circuit is configured to complete generating and processing of signaling or data information.

At least one embodiment further provides a chip system, including a processor, configured to support a computing device to implement a function in any one of the foregoing embodiments. In at least one embodiment, the chip system further includes a memory. The memory is configured to store program instructions and data. In response to the processor running the program instructions, a device on which the chip system is installed is enabled to perform the method in any one of the foregoing embodiments. For example, the chip system includes one or more chips, or includes a chip and another discrete component.

An at least one embodiment further provides a processor, configured to be coupled to a memory. The memory stores instructions, and in response to the processor running the instructions, the processor is enabled to perform the method and function in any one of the foregoing embodiments.

At least one embodiment further provides a computer program product including instructions. In response to the computer program product running on a computer, the computer is enabled to perform the method and function in any one of the foregoing embodiments.

An at least one embodiment further provides a computer-readable storage medium, storing computer instructions. In response to a processor running the instructions, the processor is enabled to perform the method and function in any one of the foregoing embodiments.

Generally, at least one embodiment is implemented by hardware or a dedicated circuit, software, logic, or any combination thereof. Some aspects are implemented by hardware, and other aspects are implemented by firmware or software, and are performed by a controller, a microprocessor, or another computing device. Although aspects of at least one embodiment are shown and illustrated as block diagrams, flowcharts, or other diagrams, the blocks, apparatuses, systems, technologies, or methods described in at least one embodiment is implemented as, for example, non-limiting examples, hardware, software, firmware, dedicated circuits, logic, general-purpose hardware, controllers, other computing devices, or a combination thereof.

At least one embodiment further provides at least one computer program product tangibly stored on a non-transitory computer-readable storage medium. The computer program product includes computer-executable instructions, for example instructions included in a program module, executed in a device on a real or virtual target processor to perform the process/method with reference to the accompanying drawings. Generally, the program module includes a routine, a program, a library, an object, a class, a component, a data structure, and the like that execute a particular task or implement a particular abstract data type. In various embodiments, functions of program modules are combined or a function of a program module is split as needed. Machine-executable instructions for the program module are executed locally or within a distributed device. In the distributed device, the program modules are located in local and remote storage media.

Computer program code used to implement the methods disclosed in at least one embodiment is written in one or more programming languages. The computer program code is provided for a processor of a general-purpose computer, a dedicated computer, or another programmable data processing apparatus, so that in response to the program code being executed by the computer or the another programmable data processing apparatus, functions/operations specified in the flowcharts and/or block diagrams are implemented. The program code is executed all on a computer, partially on a computer, as an independent software package, partially on a computer and partially on a remote computer, or all on a remote computer or server.

In a context of embodiments described herein, the computer program code or related data is carried by any appropriate carrier, so that a device, an apparatus, or a processor performs various processing and operations described above. Examples of the carrier include a signal, a computer-readable medium, and the like. For example, the signal includes propagating signals in electrical, optical, radio, sound, or other forms, such as carrier waves and infrared signals.

The computer-readable medium is any tangible medium that includes or stores a program used for or related to an instruction execution system, apparatus, or device. The computer-readable medium is a computer-readable signal medium or a computer-readable storage medium. The computer-readable medium includes but is not limited to an electronic, magnetic, optical, electromagnetic, infrared, or semiconductor system, apparatus, or device, or any suitable combination thereof. More detailed examples of the computer-readable storage medium include an electrical connection with one or more wires, a portable computer disk, a hard disk, a random access memory (RAM), a read-only memory (ROM), an erasable programmable read-only memory (EPROM or flash memory), an optical storage device, a magnetic storage device, or any suitable combination thereof.

In addition, although the operations of the methods disclosed in at least one embodiment are described in a particular order in the accompanying drawings, this does not use or imply that these operations are to be performed in the particular order or that all of the shown operations are to be performed to achieve a desired result. Instead, execution orders of the steps depicted in the flowcharts are able to change. Addition or optionally, some steps are omitted, a plurality of steps is combined into one step for execution, and/or one step is decomposed into a plurality of steps for execution. Features and functions of two or more apparatuses according to at least one embodiment are specified in one apparatus. On the contrary, features and functions of one apparatus described above are further divided into a plurality of apparatuses for materialization.

The implementations of at least one embodiment are described above. The foregoing descriptions are examples, are not exhaustive, and are not limited to the disclosed implementations. A plurality of modifications and variations are apparent to a person of ordinary skill in the art without departing from the scope and spirit of the described implementations. Selection of terms used in embodiments described herein is intended to well explain implementation principles, actual application, or improvements to technologies in the market, or to enable another person of ordinary skill in the art to understand the implementations disclosed embodiments described herein.

1. An information transmission method, performed by a terminal device or a chip of the terminal device, comprising:
receiving first indication information for monitoring combination from a network device, wherein the first indication information presents at least two candidate monitoring behaviors through whether the first indication information including a third specific parameter and whether including a fourth specific parameter, wherein the third specific parameter is usable to indicate a skipped duration in which physical downlink control channel (PDCCH) monitoring is stopped and the fourth specific parameter is usable to indicate an index of a search space set group (SSSG) to which a search space belongs;
receiving downlink control information (DCI) from the network device, wherein the DCI is usable to indicate a monitoring behavior of the terminal device, and the monitoring behavior is one of the at least two candidate monitoring behaviors; and
performing the monitoring behavior based on the first indication information and the DCI.

2. The method according to claim 1, wherein
in response to the first indication information including the third specific parameter but not including the fourth specific parameter, the first indication presents a first monitoring combination including a first candidate monitoring behavior and a second candidate monitoring behavior;
in response to the first indication information including the third specific parameter and including the fourth specific parameter, the first indication information presents a second monitoring combination including the second candidate monitoring behavior, a third candidate monitoring behavior, and a fourth candidate monitoring behavior;
in response to the first indication information not including the third specific parameter but including the fourth specific parameter and the fourth specific parameter has two types of values with 0 and 1, the first indication information presents a fourth monitoring combination including the third candidate monitoring behavior and the fourth candidate monitoring behavior; or
in response to the first indication information not including the third specific parameter but including the fourth specific parameter and the fourth specific parameter at least has three types of values with 0, 1 and 2, the first indication information presents a fifth monitoring combination including the third candidate monitoring behavior, the fourth candidate monitoring behavior, and the fifth candidate monitoring behavior, wherein
the first candidate monitoring behavior is usable to indicate to perform PDCCH monitoring based on a configured search space set, the second candidate monitoring behavior is usable to indicate to stop PDCCH monitoring within preset duration, the third candidate monitoring behavior is usable to indicate to perform PDCCH monitoring based on a search space set in a first search space set group, the fourth candidate monitoring behavior is usable to indicate to perform PDCCH monitoring based on a search space set in a second search space set group, and the fifth candidate monitoring behavior is usable to indicate to perform PDCCH monitoring based on a search space set in a third search space set group.

3. The method according to claim 1, wherein the receiving the first indication information includes receiving the first indication information that is further usable to indicate a monitoring combination of a first bandwidth part, BWP, and the method further comprises:
receiving second indication information for monitoring combination from the network device, wherein the second indication information presents a monitoring combination of a second BWP.

4. The method according to claim 1, further comprising:
sending supported monitoring combination information to the network device via UE capability information, wherein the supported monitoring combination information is usable to indicate a monitoring combination supported by the terminal device and the supported monitoring combination includes at least one of: the first monitoring combination, the second monitoring combination, the third monitoring combination, the fourth monitoring combination and the fifth monitoring combination.

5. The method according to claim 4, wherein the sending the supported monitoring combination information to the network device via the UE capability information includes sending the UE capability information that includes PdcchSkipping information element and the supported monitoring combination that includes the first monitoring combination.

6. The method according to claim 4, wherein the sending the supported monitoring combination information to the network device via the UE capability information includes sending the UE capability information that includes PdcchSkippingAndSearchSpaceSetGroupSwitching information element and the supported monitoring combination that includes the second monitoring combination.

7. The method according to claim 1, wherein the receiving DCI from the network device that is usable to indicate a monitoring behavior of the terminal device includes receiving DCI that is usable to indicate the monitoring behavior that is usable for a type 3 common search space set and a terminal device-specific search space set.

8. An apparatus, comprising:
at least one memory storing instructions; and
at least one processor coupled to the at least one memory, wherein the at least one processor is configured to execute the instructions to perform operations of:
sending first indication information for monitoring combination to a terminal device, wherein the first indication information for monitoring combination presents at least two candidate monitoring behaviors through whether the first indication information including a third specific parameter and whether including a fourth specific parameter, wherein the third specific parameter is usable to indicate a skipped duration in which physical downlink control channel (PDCCH) monitoring is stopped and the fourth specific parameter is usable to indicate an index of a search space set group (SSSG) to which a search space belongs; and
sending downlink control information (DCI) to the terminal device, wherein the DCI is usable to indicate a monitoring behavior of the terminal device and the monitoring behavior is one of the at least two candidate monitoring behaviors.

9. The apparatus according to claim 8, wherein
in response to the first indication information including the third specific parameter but not including the fourth specific parameter, the first indication presents a first monitoring combination including a first candidate monitoring behavior and a second candidate monitoring behavior;
in response to the first indication information including the third specific parameter and including the fourth specific parameter, the first indication information presents a second monitoring combination including the second candidate monitoring behavior, a third candidate monitoring behavior, and a fourth candidate monitoring behavior;
in response to the first indication information not including the third specific parameter but including the fourth specific parameter and the fourth specific parameter has two types of values with 0 and 1, the first indication information presents a fourth monitoring combination including the third candidate monitoring behavior and the fourth candidate monitoring behavior; or
in response to the first indication information not including the third specific parameter but including the fourth specific parameter and the fourth specific parameter at least has three types of values with 0, 1 and 2, the first indication information presents a fifth monitoring combination including the third candidate monitoring behavior, the fourth candidate monitoring behavior, and the fifth candidate monitoring behavior, wherein
the first candidate monitoring behavior is usable to indicate to perform PDCCH monitoring based on a configured search space set, the second candidate monitoring behavior is usable to indicate to stop PDCCH monitoring within preset duration, the third candidate monitoring behavior is usable to indicate to perform PDCCH monitoring based on a search space set in a first search space set group, the fourth candidate monitoring behavior is usable to indicate to perform PDCCH monitoring based on a search space set in a second search space set group, and the fifth candidate monitoring behavior is usable to indicate to perform PDCCH monitoring based on a search space set in a third search space set group.

10. The apparatus according to claim 8, wherein the first indication information further is usable to indicate a monitoring combination of a first bandwidth part, BWP, and the method further comprises:
sending second indication information for monitoring combination to the terminal device, wherein the second indication information is usable to indicate a monitoring combination of a second BWP.

11. The apparatus according to claim 8, further comprising:
receiving UE capability information including supported monitoring combination information from the terminal device, wherein the supported monitoring combination information is usable to indicate a monitoring combination supported by the terminal device, and the supported monitoring combination includes at least one of: the first monitoring combination, the second monitoring combination, the third monitoring combination, the fourth monitoring combination and the fifth monitoring combination.

12. The apparatus according to claim 11, wherein the UE capability information includes PdcchSkipping information element and the supported monitoring combination includes the first monitoring combination.

13. The apparatus according to claim 11, wherein the UE capability information includes PdcchSkippingAndSearchSpaceSetGroupSwitching information element and the supported monitoring combination includes the second monitoring combination.

14. The apparatus according to claim 8, wherein the monitoring behavior is usable for a type 3 common search space set and a terminal device-specific search space set.

15. An apparatus, comprising:
at least one memory storing instructions; and
at least one processor coupled to the at least one memory, wherein the at least one processor is configured to execute the instructions to perform operations of:
receiving first indication information for monitoring combination from a network device, wherein the first indication information presents at least two candidate monitoring behaviors through whether the first indication information including a third specific parameter and whether including a fourth specific parameter, wherein the third specific parameter is usable to indicate a skipped duration in which physical downlink control channel (PDCCH) monitoring is stopped and the fourth specific parameter is usable to indicate an index of a search space set group (SSSG) to which a search space belongs;
receiving downlink control information (DCI) from the network device, wherein the DCI is usable to indicate a monitoring behavior of the apparatus, and the monitoring behavior is one of the at least two candidate monitoring behaviors; and
performing the monitoring behavior based on the first indication information and the DCI.

16. The apparatus according to claim 15, wherein
in response to the first indication information including the third specific parameter but not including the fourth specific parameter, the first indication presents a first monitoring combination including a first candidate monitoring behavior and a second candidate monitoring behavior;
in response to the first indication information including the third specific parameter and including the fourth specific parameter, the first indication information presents a second monitoring combination including the second candidate monitoring behavior, a third candidate monitoring behavior, and a fourth candidate monitoring behavior;
in response to the first indication information not including the third specific parameter but including the fourth specific parameter and the fourth specific parameter has two types of values with 0 and 1, the first indication information presents a fourth monitoring combination including the third candidate monitoring behavior and the fourth candidate monitoring behavior; or
in response to the first indication information not including the third specific parameter but including the fourth specific parameter and the fourth specific parameter at least has three types of values with 0, 1 and 2, the first indication information presents a fifth monitoring combination including the third candidate monitoring behavior, the fourth candidate monitoring behavior, and the fifth candidate monitoring behavior, wherein
the first candidate monitoring behavior is usable to indicate to perform PDCCH monitoring based on a configured search space set, the second candidate monitoring behavior is usable to indicate to stop PDCCH monitoring within preset duration, the third candidate monitoring behavior s usable to indicate to perform PDCCH monitoring based on a search space set in a first search space set group, the fourth candidate monitoring behavior is usable to indicate to perform PDCCH monitoring based on a search space set in a second search space set group, and the fifth candidate monitoring behavior is usable to indicate to perform PDCCH monitoring based on a search space set in a third search space set group.

17. The apparatus according to claim 15, wherein the first indication information further is usable to indicate a monitoring combination of a first bandwidth part, BWP, and the method further comprises:
receiving second indication information for monitoring combination from the network device, wherein the second indication information presents a monitoring combination of a second BWP.

18. The apparatus according to claim 15, the operations further comprising:
sending supported monitoring combination information to the network device via UE capability information, wherein the supported monitoring combination information is usable to indicate a monitoring combination supported by the terminal device and the supported monitoring combination includes at least one of: the first monitoring combination, the second monitoring combination, the third monitoring combination, the fourth monitoring combination and the fifth monitoring combination.

19. The apparatus according to claim 18, wherein the UE capability information includes PdcchSkipping information element and the supported monitoring combination includes the first monitoring combination; or wherein the UE capability information includes PdcchSkippingAndSearchSpaceSetGroupSwitching information element and the supported monitoring combination includes the second monitoring combination.

20. The apparatus according to claim 15, wherein the monitoring behavior is usable for a type 3 common search space set and a terminal device-specific search space set.
